(19) United States
(12) Patent Application Publication
(10) Pub. No.: US 2025/0250291 A1
(43) Pub. Date: Aug. 7, 2025

(54) PREPARATION OF ORGANOSILICON COMPOUNDS WITH ALDEHYDE FUNCTIONALITY

(71) Applicant: DOW GLOBAL TECHNOLOGIES LLC, Midland, MI (US)

(72) Inventors: Michael TULCHINSKY, Midland, MI (US); Souvagya BISWAS, Midland, MI (US); Michael A. BRAMMER, Freeport, TX (US); Ruth FIGUEROA, Midland, MI (US); Heather SPINNEY, Midland, MI (US); Haoquan LI, Midland, MI (US)

(21) Appl. No.: 18/856,554

(22) PCT Filed: Apr. 13, 2023
(86) PCT No.: PCT/US2023/018464

§ 371 Date: Oct. 11, 2024

Related U.S. Application Data
(60) Provisional application No. 63/330,571, filed on Apr. 13, 2022.

(51) Int. Cl. C07F 7/08

(52) U.S. Cl. CPC C07F 7/087

(57) ABSTRACT

A process for preparing an aldehyde-functional organosilicon compound comprises: 1) combining, under conditions to catalyze hydroformylation reaction, starting materials comprising (A) a gas comprising hydrogen and carbon monoxide, (B) a vinyl-functional organosilicon compound, and (C) a rhodium/ligand complex catalyst.

### CROSS-REFERENCE TO RELATED APPLICATIONS

This application claims priority to and all advantages of U.S. Provisional Patent Application No. 63/330,571 filed on 13 Apr. 2022, the content of which is incorporated herein by reference.

### TECHNICAL FIELD

A process for preparing an aldehyde-functional organosilicon compound is disclosed. More particularly, the process for preparing the aldehyde-functional organosilicon compound employs a rhodium/ligand complex catalyst for hydroformylation of a vinyl-functional organosilicon compound with carbon monoxide and hydrogen.

### BACKGROUND

Aldehydes are important intermediates in the synthesis of other functionalized materials like alcohols, carboxylic acids, and amines. The introduction of aldehyde functionality into organosilicon compounds such as silanes and siloxanes affords the opportunity to generate a wide variety of organic functionalized organosilicon compounds.

Existing methods for preparing aldehyde-functional organosilicon compounds (e.g., silanes and siloxanes) may suffer from one or more drawbacks such as requiring multiple chemical steps, drastic conditions, and/or high catalyst loadings; and such methods may also have slow reaction rates and/or produce undesirable by-products. U.S. Pat. No. 7,999,053 discloses one means for preparing aldehyde functional siloxanes, which involves the reaction of a hydride functional siloxane with an acetal containing an alpha-olefin group. After the hydrosilylation is complete, the aldehyde is then liberated using an acidic catalyst and water. This reaction is typically biphasic, generates significant amounts of waste by-products, and requires multiple steps to recover the desired product.

Ozonolysis is another route to aldehyde functional siloxanes. This route involves the exposure of an olefin functional siloxane to ozone to form silicone ozonides. The ozonides can be further reacted under acidic conditions to form aldehydes. This route also has multiple steps.

The Grignard coupling of bromophenyldioxolanes with chlorosilanes and subsequent hydrosilylation with vinyl functional siloxanes is another method for preparing aldehyde functional siloxanes. This method also has multiple steps and generates waste.

Another possible route to aldehyde functional silicones is the hydrosilylation of SiH functional siloxanes with (non-silicon) aldehyde compounds that also contain other unsaturated carbon-carbon bonds. This route may suffer from the drawback of competing reaction of the addition of the SiH across the aldehyde carbonyl group. Furthermore, hydrosilylation routes may also suffer from the drawback of forming large amounts of branched isomer, an undesirable by-product.

Hydroformylation of vinyl functional silanes and vinyl-functional siloxanes has also been proposed. However, previously proposed processes suffer from one or more of the following drawbacks: slow reaction rate, low selectivity to a desired linear isomer product, and high catalyst loading required for the reaction. Slow reaction rate leads to low productivity. The high catalyst loading needed would lead to difficulties in catalyst recycling. Low linear selectivity would lead to product decomposition because the branched product tends to undergo Brook rearrangement reaction.

### BRIEF SUMMARY

A process for preparing an aldehyde-functional organosilicon compound is disclosed. The process comprises: 1) combining, under conditions to catalyze hydroformylation reaction, starting materials comprising (A) a gas comprising hydrogen and carbon monoxide, (B) a vinyl-functional organosilicon compound, and (C) a rhodium/ligand complex catalyst.

### DETAILED DESCRIPTION

The hydroformylation process described herein employs starting materials comprising: (A) a gas comprising hydrogen and carbon monoxide, (B) a vinyl-functional organosilicon compound, and (C) a rhodium/ligand complex catalyst. The starting materials may optionally further comprise (D) a solvent.

Starting material (A), the gas used in the hydroformylation process, comprises carbon monoxide (CO) and hydrogen gas (H₂). For example, the gas may be syngas. As used herein, “syngas” (from synthesis gas) refers to a gas mixture that contains varying amounts of CO and H₂. Production methods are well known and include, for example: (1) steam reforming and partial oxidation of natural gas or liquid hydrocarbons, and (2) the gasification of coal and/or biomass. CO and H₂ typically are the main components of syngas, but syngas may contain carbon dioxide and inert gases such as CH₄, N₂ and Ar. The molar ratio of H₂ to CO (H₂:CO molar ratio) varies greatly but may range from 1:100 to 100:1, alternatively 1:10 and 10:1. Syngas is commercially available and is often used as a fuel source or as an intermediate for the production of other chemicals. Alternatively, CO and H₂ from other sources (i.e., other than syngas) may be used as starting material (A) herein. Alternatively, the H₂:CO molar ratio in starting material (A) for use herein may be 3:1 to 1:3, alternatively 2:1 to 1:2, and alternatively 1:1.

The vinyl-functional organosilicon compound has, per molecule, at least one vinyl group covalently bonded to silicon. Alternatively, the vinyl-functional organosilicon compound may have, per molecule, more than one vinyl group covalently bonded to silicon. Starting material (B) may be one vinyl-functional organosilicon compound. Alternatively, starting material (B) may comprise two or more vinyl-functional organosilicon compounds that differ from one another. For example, the vinyl-functional organosilicon compound may comprise one or both of (B1) a silane and (B2) a polyorganosiloxane.

Starting material (B1), the vinyl-functional silane, may have formula (B1-1): R^{A}ₓSiR²³₍₄₋ₓ₎, where each R^{A} is a vinyl group; each R²³ is independently selected from the group consisting of an alkyl group of 1 to 18 carbon atoms, an aryl group of 6 to 18 carbon atoms, an acyloxy group of 2 to 18 carbon atoms, and a hydrocarbonoxy-functional group of 1 to 18 carbon atoms; and subscript x is 1 to 4. Alternatively, subscript x may be 1 or 2, alternatively 2, and alternatively 1. Alternatively, each R²³ may be independently selected from the group consisting of an alkyl group of 1 to 18 carbon atoms, an aryl group of 6 to 18 carbon atoms, an acyloxy group of 1 to 18 carbon atoms, and a hydrocarbonoxy-functional group of 1 to 18 carbon atoms. Alternatively, each R²³ may be independently selected from the group consisting of an alkyl group of 1 to 18 carbon atoms, an aryl group of 6 to 18 carbon atoms, and an alkoxy-functional group of 1 to 18 carbon atoms. Alternatively, each R²³ in formula (B1-1) may be independently selected from the group consisting of an alkyl group of 1 to 18 carbon atoms, an aryl group of 6 to 18 carbon atoms, and a hydrocarbonoxy-functional group of 1 to 18 carbon atoms.

Suitable alkyl groups for R²³ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Alternatively, the alkyl group for R²³ may be selected from the group consisting of methyl, ethyl, propyl and butyl; alternatively methyl, ethyl, and propyl; alternatively methyl and ethyl. Alternatively, the alkyl group for R²³ may be methyl.

Suitable aryl groups for R²³ may be monocyclic or polycyclic and may have pendant hydrocarbyl groups. For example, the aryl groups for R²³ include phenyl, tolyl, xylyl, and naphthyl and further include aralkyl groups such as benzyl, 1-phenylethyl and 2-phenylethyl. Alternatively, the aryl group for R²³ may be monocyclic, such as phenyl, tolyl, or benzyl; alternatively the aryl group for R²³ may be phenyl.

Suitable hydrocarbonoxy-functional groups for R²³ may have the formula —OR²⁴ or the formula —OR²⁵—OR²⁴, where each R²⁵ is an independently selected divalent hydrocarbyl group of 1 to 18 carbon atoms, and each R²⁴ is independently selected from the group consisting of the alkyl groups of 1-18 carbon atoms and the aryl groups of 6-18 carbon atoms, which are as described and exemplified above for R²³. Examples of divalent hydrocarbyl groups for R²⁵ include alkylene group such as ethylene, propylene, butylene, or hexylene; an arylene group such as phenylene, or an alkylarylene group such as:

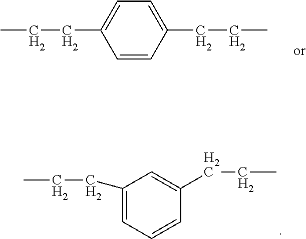

Alternatively, R²⁵ may be an alkylene group such as ethylene. Alternatively, the hydrocarbonoxy-functional group may be an alkoxy-functional group such as methoxy, ethoxy, propoxy, or butoxy; alternatively methoxy or ethoxy, and alternatively methoxy.

Suitable acyloxy groups for R²³ may have the formula

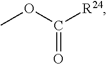

where R²⁴ is as described above. Examples of suitable acyloxy groups include acetoxy. Vinyl-functional acyloxysilanes and methods for their preparation are known in the art, for example, in U.S. Pat. No. 5,387,706 to Rasmussen, et al., and U.S. Pat. No. 5,902,892 to Larson, et al.

Suitable vinyl-functional silanes are exemplified by vinyl-functional trialkylsilanes such as vinyltrimethylsilane, vinyltriethylsilane; vinyl-functional trialkoxysilanes such as vinyltrimethoxysilane, vinyltriethoxysilane, vinyltriisopropoxysilane, and vinyltris(methoxyethoxy) silane; vinyl-functional dialkoxysilanes such as vinylphenyldiethoxysilane, vinylmethyldimethoxysilane, and vinylmethyldiethoxysilane; vinyl-functional monoalkoxysilanes such as trivinylmethoxysilane; vinyl-functional triacyloxysilanes such as vinyltriacetoxysilane, and vinyl-functional diacyloxysilanes such as vinylmethyldiacetoxysilane. All of these vinyl-functional silanes are commercially available from Gelest Inc. of Morrisville, Pennsylvania, USA. Furthermore, vinyl-functional silanes may be prepared by known methods, such as those disclosed in U.S. Pat. No. 4,898,961 to Baile, et al. and U.S. Pat. No. 5,756,796 to Davern, et al.

Alternatively, (B) the vinyl-functional organosilicon compound may comprise (B2) a vinyl-functional polyorganosiloxane. The vinyl-functional polyorganosiloxane may be cyclic, linear, branched, resinous, or a combination of two or more thereof. The vinyl-functional polyorganosiloxane may comprise unit formula (B2-1): (R²³₃SiO_{1/2})ₐ(R²³₂R^{A}SiO_{1/2})_{b}(R²³₂SiO_{2/2})_{c}(R²³R^{A}SiO_{2/2})ₐ(R²³SiO_{3/2})ₑ(R^{A}SiO_{3/2})_{f}(SiO_{4/2})_{g}(ZO_{1/2})ₕ; where R^{A} and R²³ are as described above; each Z is independently selected from the group consisting of a hydrogen atom and R²⁴ (where R²⁴ is as described above), subscripts a, b, c, d, e, f, and g represent numbers of each unit in formula (B2-1) and have values such that subscript a≥0, subscript b≥0, subscript c≥0, subscript d≥0, subscript e≥0, subscript f≥0, and subscript g≥0; a quantity (a+b+c+d+e+f+g)≥2, and a quantity (b+d+f)≥1, and subscript h has a value such that 0≤h/(e+f+g)≤1.5. At the same time, the quantity (a+b+c+d+e+f+g) may be ≤10,000. Alternatively, in formula (B-2-1), each R²³ may be independently selected from the group consisting of a hydrogen atom, an alkyl group of 1 to 18 carbon atoms, an aryl group of 6 to 18 carbon atoms, and a hydrocarbonoxy-functional group of 1 to 18 carbon atoms. Alternatively, each R²³ may be independently selected from the group consisting of an alkyl group of 1 to 18 carbon atoms, an aryl group of 6 to 18 carbon atoms, and an alkoxy-functional group of 1 to 18 carbon atoms. Alternatively, each R²³ may be independently selected from the group consisting of an alkyl group of 1 to 18 carbon atoms and an aryl group of 6 to 18 carbon atoms. Alternatively, each Z may be hydrogen or an alkyl group of 1 to 6 carbon atoms. Alternatively, each Z may be hydrogen.

Alternatively, (B2) the vinyl-functional polyorganosiloxane may comprise (B2-2) a linear polydiorganosiloxane having, per molecule, at least one vinyl group; alternatively at least two vinyl groups (e.g., when in formula B2-1) above, subscripts e=f=g=0). For example, said polydiorganosiloxane may comprise unit formula (B2-3): (R²³₃SiO_{1/2})ₐ(R^{A}R²³₂SiO_{1/2})_{b}(R²³₂SiO_{2/2})_{c}(R^{A}R²³SiO_{2/2})ₐ, where R^{A} and R²³ are as described above, subscript a is 0, 1, or 2; subscript b is 0, 1, or 2, subscript c≥0, subscript d≥0, with the provisos that a quantity (b+d)≥1, a quantity (a+b)=2, and a quantity (a+b+c+d)≥2. Alternatively, in unit formula (B2-3) the quantity (a+b+c+d) may be at least 3, alternatively at least 4, and alternatively >50. At the same time in unit formula (B2-3), the quantity (a+b+c+d) may be less than or equal to 10,000; alternatively less than or equal to 4,000; alternatively less than or equal to 2,000; alternatively less than or equal to 1,000; alternatively less than or equal to 500; alternatively less than or equal to 250. Alternatively, in unit formula (B2-3) each R²³ may be independently selected from the group consisting of alkyl and aryl; alternatively methyl and phenyl. Alternatively, each R²³ in unit formula (B2-3) may be an alkyl group; alternatively each R²³ may be methyl.

Alternatively, the polydiorganosiloxane of unit formula (B2-3) may be selected from the group consisting of: unit formula (B2-4): (R²³₂R^{A}SiO_{1/2})₂ (R²³₂SiO_{2/2})ₘ(R²³R^{A}SiO_{2/2})ₙ, unit formula (B2-5): (R²³₃SiO_{1/2})₂ (R²³₂SiO_{2/2})ₒ(R²³R^{A}SiO_{2/2})ₚ, or a combination of both (B2-4) and (B2-5).

In formulae (B2-4) and (B2-5), each R²³ and R^{A} are as described above. Subscript m may be 0 or a positive number. Alternatively, subscript m may be at least 2. Alternatively subscript m be 2 to 2,000. Subscript n may be 0 or a positive number. Alternatively, subscript n may be 0 to 2000. Subscript o may be 0 or a positive number. Alternatively, subscript o may be 0 to 2000. Subscript p is at least 2. Alternatively subscript p may be 2 to 2000.

Starting material (B2) may comprise a vinyl-functional polydiorganosiloxane such as i) bis-dimethylvinylsiloxy-terminated polydimethylsiloxane, ii) bis-dimethylvinylsiloxy-terminated poly(dimethylsiloxane/methylvinylsiloxane), iii) bis-dimethylvinylsiloxy-terminated polymethylvinylsiloxane, iv) bis-trimethylsiloxy-terminated poly(dimethylsiloxane/methylvinylsiloxane), v) bis-trimethylsiloxy-terminated polymethylvinylsiloxane, vi) bis-dimethylvinylsiloxy-terminated poly(dimethylsiloxane/methylphenylsiloxane/methylvinylsiloxane), vii) bis-dimethylvinylsiloxy-terminated poly(dimethylsiloxane/methylphenylsiloxane), viii) bis-dimethylvinylsiloxy-terminated poly(dimethylsiloxane/diphenylsiloxane), ix) bis-phenyl,methyl,vinyl-siloxy-terminated polydimethylsiloxane, x) bis-dimethylvinylsiloxy-terminated poly(dimethylsiloxane/methylhexenylsiloxane), and xi) a combination of two or more of i) to x).

Methods of preparing linear vinyl-functional polydiorganosiloxanes described above for starting material (B2), such as hydrolysis and condensation of the corresponding organohalosilanes and oligomers or equilibration of cyclic polydiorganosiloxanes, are known in the art, see for example U.S. Pat. Nos. 3,284,406; 4,772,515; 5,169,920; 5,317,072; and 6,956,087, which disclose preparing linear polydiorganosiloxanes with vinyl groups. Examples of linear polydiorganosiloxanes having vinyl groups are commercially available from, e.g., Gelest Inc. of Morrisville, Pennsylvania, USA under the tradenames DMS-V00, DMS-V03, DMS-V05, DMS-V21, DMS-V22, DMS-V25, DMS-V-31, DMS-V33, DMS-V34, DMS-V35, DMS-V41, DMS-V42, DMS-V43, DMS-V46, DMS-V51, DMS-V52.

Alternatively, (B2) the vinyl-functional polyorganosiloxane may be cyclic, e.g., when in unit formula (B2-1), subscripts a=b=c=e=f=g=h=0. The cyclic vinyl-functional polydiorganosiloxane may have unit formula (B2-7): (R²³R^{A}SiO_{2/2})_{d}, where R^{A} and R²³ are as described above, and subscript d may be 3 to 12, alternatively 3 to 6, and alternatively 4 to 5. Examples of cyclic vinyl-functional polydiorganosiloxanes include 2,4,6-trimethyl-2,4,6-trivinyl-cyclotrisiloxane, 2,4,6,8-tetramethyl-2,4,6,8-tetravinyl-cyclotetrasiloxane, 2,4,6,8,10-pentamethyl-2,4,6,8,10-pentavinyl-cyclopentasiloxane, and 2,4,6,8,10,12-hexamethyl-2,4,6,8,10,12-hexavinyl-cyclohexasiloxane. These cyclic vinyl-functional polydiorganosiloxanes are known in the art and are commercially available from, e.g., Sigma-Aldrich of St. Louis, Missouri, USA; Milliken of Spartanburg, South Carolina, USA; and other vendors.

Alternatively, the cyclic vinyl-functional polydiorganosiloxane may have unit formula (B2-8): (R²³₂SiO_{2/2})_{c′}(R²³R^{A}SiO₂)_{d}, where R³ and R^{A} are as described above, subscript c′ is >0 to 6 and subscript d is 3 to 12. Alternatively, in formula (B2-8), c′ may be 3 to 6, and d may be 3 to 6.

Alternatively, (B2) the vinyl-functional polyorganosiloxane may be oligomeric, e.g., when in unit formula (B2-1) above the quantity (a+b+c+d+e+f+g)≤50, alternatively ≤40, alternatively ≤30, alternatively ≤25, alternatively ≤20, alternatively ≤10, alternatively ≤5, alternatively ≤4, alternatively ≤3. The oligomer may be cyclic, linear, branched, or a combination thereof. The cyclic oligomers are as described above as starting material (B2-6).

Examples of linear vinyl-functional polyorganosiloxane oligomers may have formula (B2-10):

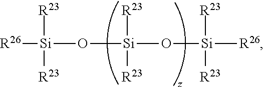

where R³ is as described above, each R²⁶ is independently selected from the group consisting of R²³ and R^{A}, with the proviso that at least one R²⁶, per molecule, is R^{A}, and subscript z is 0 to 48. Examples of linear vinyl-functional polyorganosiloxane oligomers may have include 1,3-divinyl-1,1,3,3-tetramethyldisiloxane; 1,1,1,3,3-pentamethyl-3-vinyl-disiloxane; 1,1,1,3,5,5,5-heptamethyl-3-vinyl-trisiloxane, all of which are commercially available, e.g., from Gelest, Inc. of Morrisville, Pennsylvania, USA or Sigma-Aldrich of St. Louis, Missouri, USA.

Alternatively, the vinyl-functional polyorganosiloxane oligomer may be branched. The branched oligomer may have general formula (B2-11): R_{A}SiR²⁷₃, where R^{A} is as described above and each R²⁷ is selected from R²⁹ and —OSi(R²⁹)₃; where each R²⁸ is a monovalent hydrocarbon group; where each R²⁹ is selected from R²⁷, —OSi(R³)₃, and —[OSiR²⁸₂]ᵢᵢOSiR²⁸₃; where each R³⁰ is selected from R²⁷, —OSi(R³¹)₃, and —[OSiR²⁸₂]ᵢᵢOSiR²⁸₃; where each R³¹ is selected from R²⁸ and —[OSiR²⁸₂]ᵢᵢOSiR²⁸₃; and where subscript ii has a value such that 0≤ii≤100. At least two of R²⁷ may be —OSi(R²)₃. Alternatively, all three of R²⁷ may be —OSi(R²)₃.

Alternatively, in formula (B2-11) when each R²⁷ is —OSi(R²)₃, each R⁹ may be —OSi(R³)₃ moieties such that the branched polyorganosiloxane oligomer has the following structure:

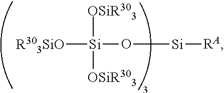

where R^{A} and R³⁰ are as described above. Alternatively, each R³⁰ may be an R²⁸, as described above, and each R²⁸ may be methyl.

Alternatively, in formula (B2-11), when each R²⁷ is —OSi(R²⁹)₃, one R²⁹ may be R²⁸ in each —OSi(R²⁹)₃ such that each R²⁷ is —OSiR²⁸(R²⁹)₂. Alternatively, two R²⁹ in —OSiR₂₈(R²⁹)₂ may each be —OSi(R³⁰)₃ moieties such that the branched polyorganosiloxane oligomer has the following structure:

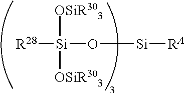

where R^{A}, R²⁸, and R³⁰ are as described above. Alternatively, each R³⁰ may be an R²⁸, and each R²⁸ may be methyl.

Alternatively, in formula (B2-11), one R²⁷ may be R²⁸, and two of R²⁷ may be —OSi(R²⁹)₃. When two of R²⁷ are —OSi(R²⁹)₃, and one R²⁹ is R²⁸ in each —OSi(R²⁹)₃ then two of R²⁷ are —OSiR²⁸ (R²⁹)₂. Alternatively, each R²⁹ in —OSiR²⁸(R²⁹)₂ may be —OSi(R³⁰)₃ such that the branched polyorganosiloxane oligomer has the following structure:

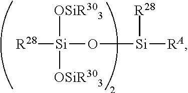

where R^{A}, R²⁸, and R³⁰ are as described above. Alternatively, each R³⁰ may be an R²⁸, and each R²⁸ may be methyl. Alternatively, the vinyl-functional branched polyorganosiloxane may have 3 to 16 silicon atoms per molecule, alternatively 4 to 16 silicon atoms per molecule, and alternatively 4 to 10 silicon atoms per molecule. Examples of vinyl-functional branched polyorganosiloxane oligomers include vinyl-tris(trimethyl)siloxy)silane, which has formula:

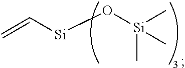

(1,1,1,3,5,7,9,9,9-nonamethyl-3,7-bis((trimethylsilyl)oxy)-5-vinylpentasiloxane), which has formula

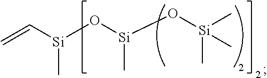

and (5-((1,1,1,3,5,5,5-heptamethyltrisiloxan-3-yl)oxy)-1,1,1,3,7,9,9,9-octamethyl-3,7-bis((trimethylsilyl)oxy)-5-vinylpentasiloxane), which has formula

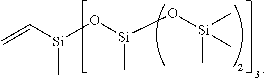

Branched vinyl-functional polyorganosiloxane oligomers described above may be prepared by known methods, such as those disclosed in “Testing the Functional Tolerance of the Piers-Rubinsztajn Reaction: A new Strategy for Functional Silicones” by Grande, et al. Supplementary Material (ESI) for Chemical Communications, © The Royal Society of Chemistry 2010.

Alternatively, (B2) the vinyl-functional polyorganosiloxane may be branched, such as the branched oligomer described above and/or a branched vinyl-functional polyorganosiloxane that may have, e.g., more vinyl groups per molecule and/or more polymer units than the branched oligomer described above (e.g., in formula (B2-1) when the quantity (a+b+c+d+e+f+g)>50). The branched vinyl-functional polyorganosiloxane may have (in formula (B2-1)) a quantity (e+f+g) sufficient to provide >0 to 5 mol % of trifunctional and/or quadrifunctional units to the branched vinyl-functional polyorganosiloxane.

For example, the branched vinyl-functional polyorganosiloxane may comprise a Q branched polyorganosiloxane of unit formula (B2-13): (R²³₃SiO_{1/2})ₐ(R²³₂R^{A}SiO_{1/2})ᵣ(R²³₂SiO_{2/2})ₛ(SiO_{4/2})ₜ, where R²³ and R^{A} are as described above, and subscripts q, r, s, and t have average values such that 2≥q≥0, 4≥r≥0, 995≥s≥4, t=1, (q+r)=4, and (q+r+s+t) has a value sufficient to impart a viscosity >170 mPa's measured by rotational viscometry (as described below with the test methods) to the branched polyorganosiloxane. Alternatively, viscosity may be >170 mPa·s to 1000 mPa·s, alternatively >170 to 500 mPa·s, alternatively 180 mPa·s to 450 mPa·s, and alternatively 190 mPa·s to 420 mPa·s. Suitable Q branched polyorganosiloxanes for starting material (B2-12) are known in the art and can be made by known methods, exemplified by those disclosed in U.S. Pat. No. 6,806,339 to Cray, et al. and U.S. Patent Publication 2007/0289495 to Cray, et al.

Alternatively, the branched vinyl-functional polyorganosiloxane may comprise formula (B2-14): [R^{A}R²³₂Si—(O—SiR²³₂)ₓ—O]_{(4-w)}—Si—[O—(R²³₂SiO)ᵥSiR²³₃]_{w}, where R^{A} and R²³ are as described above; and subscripts v, w, and x have values such that 200≥v≥1, 2≥w≥0, and 200≥x≥1. Alternatively, in this formula (B2-14), each R²³ is independently selected from the group consisting of methyl and phenyl, and each R^{A} is vinyl. Branched polyorganosiloxane suitable for starting material (B2-14) may be prepared by known methods such as heating a mixture comprising a polyorganosilicate resin, and a cyclic polydiorganosiloxane or a linear polydiorganosiloxane, in the presence of a catalyst, such as an acid or phosphazene base, and thereafter neutralizing the catalyst.

Alternatively, the branched vinyl-functional polyorganosiloxane for starting material (B2-11) may comprise a T branched polyorganosiloxane of unit formula (B2-15): (R²³₃SiO_{1/2})ₐₐ(R^{A}R²³₂SiO_{1/2})_{bb}(R²³₂SiO_{2/2})_{cc}(R^{A}R²³SiO_{2/2})ₑₑ(R²³SiO_{3/2}) da, where R²³ and R^{A} are as described above, subscript aa>0, subscript bb>0, subscript cc is 15 to 995, subscript dd>0, and subscript ee≥0. Subscript aa may be 0 to 10. Alternatively, subscript aa may have a value such that: 12≥aa≥0; alternatively 10≥aa≥0; alternatively 7≥aa≥0; alternatively 5≥aa≥0; and alternatively 3≥aa≥0. Alternatively, subscript bb≥1. Alternatively, subscript bb≥3. Alternatively, subscript bb may have a value such that: 12≥bb>0; alternatively 12≥bb≥3; alternatively 10≥bb>0; alternatively 7≥bb>1; alternatively 5≥bb≥2; and alternatively 7≥bb≥3. Alternatively, subscript cc may have a value such that: 800≥cc≥15; and alternatively 400≥cc≥15. Alternatively, subscript ee may have a value such that: 800≥ee≥0; 800≥ee≥15; and alternatively 400≥ee≥15. Alternatively, subscript ee may b 0. Alternatively, a quantity (cc+ee) may have a value such that 995≥(cc+ee)≥15. Alternatively, subscript dd≥1. Alternatively, subscript dd may be 1 to 10. Alternatively, subscript dd may have a value such that: 10≥dd>0; alternatively 5≥dd>0; and alternatively dd=1. Alternatively, subscript dd may be 1 to 10, alternatively subscript dd may be 1 or 2. Alternatively, when subscript dd=1, then subscript bb may be 3 and subscript cc may be 0. The values for subscript bb may be sufficient to provide the silsesquioxane of unit formula (B2-15) with a vinyl content of 0.1% to 1%, alternatively 0.2% to 0.6%, based on the weight of the silsesquioxane. Suitable T branched polyorganosiloxanes (silsesquioxanes) for starting material (B2-15) are exemplified by those disclosed in U.S. Pat. No. 4,374,967 to Brown, et al; U.S. Pat. No. 6,001,943 to Enami, et al.; U.S. Pat. No. 8,546,508 to Nabeta, et al.; and U.S. Pat. No. 10,155,852 to Enami.

Alternatively, (B2) the vinyl-functional polyorganosiloxane may comprise a vinyl-functional polyorganosilicate resin, which comprises monofunctional units (“M” units) of formula R^{M}₃SiO_{1/2} and tetrafunctional silicate units (“Q” units) of formula SiO_{4/2}, where each R^{M} is an independently selected monovalent hydrocarbon group; each R^{M} may be independently selected from the group consisting of R²³ and R^{A} as described above. Alternatively, each R^{M} may be selected from the group consisting of alkyl, vinyl and aryl. Alternatively, each R^{M} may be selected from methyl, vinyl and phenyl. Alternatively, at least one-third, alternatively at least two thirds of the R^{M} groups are methyl groups. Alternatively, the M units may be exemplified by (Me₃SiO_{1/2}), (Me₂PhSiO_{1/2}), and (Me₂ViSiO_{1/2}). The polyorganosilicate resin is soluble in solvents such as those described herein as starting material (D), exemplified by liquid hydrocarbons, such as benzene, ethylbenzene, toluene, xylene, and heptane, or in liquid non-functional organosilicon compounds such as low viscosity linear and cyclic polydiorganosiloxanes.

When prepared, the polyorganosilicate resin comprises the M and Q units described above, and the polyorganosiloxane further comprises units with silicon bonded hydroxyl groups, and/or hydrolyzable groups, described by moiety (ZO_{1/2}), above, and may comprise neopentamer of formula Si(OSiR^{M}₃)₄, where R^{M} is as described above, e.g., the neopentamer may be tetrakis(trimethylsiloxy)silane. ²⁹Si NMR and ¹³C NMR spectroscopies may be used to measure hydroxyl and alkoxy content and molar ratio of M and Q units, where said ratio is expressed as {M(resin)}/{Q(resin)}, excluding M and Q units from the neopentamer. M/Q ratio represents the molar ratio of the total number of triorganosiloxy groups (M units) of the resinous portion of the polyorganosilicate resin to the total number of silicate groups (Q units) in the resinous portion. M/Q ratio may be 0.5/1 to 1.5/1, alternatively 0.6/1 to 0.9/1.

The Mn of the polyorganosilicate resin depends on various factors including the types of hydrocarbon groups represented by R^{M} that are present. The Mn of the polyorganosilicate resin refers to the number average molecular weight measured using GPC, when the peak representing the neopentamer is excluded from the measurement. The Mn of the polyorganosilicate resin may be from 1,500 to 30,000, alternatively from 1,500 to 15,000; alternatively from >3,000 to 8,000 Da. Alternatively, Mn of the polyorganosilicate resin may be 3,500 to 8,000 Da.

U.S. Pat. No. 8,580,073 at col. 3, line 5 to col. 4, line 31, and U.S. Patent Publication 2016/0376482 at paragraphs to are hereby incorporated by reference for disclosing MQ resins, which are suitable polyorganosilicate resins for use as starting material (B2). The polyorganosilicate resin can be prepared by any suitable method, such as cohydrolysis of the corresponding silanes or by silica hydrosol capping methods. The polyorganosilicate resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M units and Q units. The resulting copolymers generally contain from 2 to 5 percent by weight of hydroxyl groups.

The intermediates used to prepare the polyorganosilicate resin may be triorganosilanes and silanes with four hydrolyzable substituents or alkali metal silicates. The triorganosilanes may have formula R^{M}₃SiX, where R^{M} is as described above and X represents a hydroxyl group or a hydrolyzable substituent, e.g., of formula OZ described above. Silanes with four hydrolyzable substituents may have formula SiX²₄, where each X² is independently selected from the group consisting of halogen, alkoxy, and hydroxyl. Suitable alkali metal silicates include sodium silicate.

The polyorganosilicate resin prepared as described above typically contain silicon bonded hydroxyl groups, e.g., of formula, HOSiO_{3/2}. The polyorganosilicate resin may comprise up to 3.5% of silicon bonded hydroxyl groups, as measured by FTIR spectroscopy and/or NMR spectroscopy, as described above. For certain applications, it may desirable for the amount of silicon bonded hydroxyl groups to be below 0.7%, alternatively below 0.3%, alternatively less than 1%, and alternatively 0.3% to 0.8%. Silicon bonded hydroxyl groups formed during preparation of the polyorganosilicate resin can be converted to trihydrocarbon siloxane groups or to a different hydrolyzable group by reacting the silicone resin with a silane, disiloxane, or disilazane containing the appropriate terminal group. Silanes containing hydrolyzable groups may be added in molar excess of the quantity required to react with the silicon bonded hydroxyl groups on the polyorganosilicate resin.

Alternatively, the polyorganosilicate resin may further comprise 2% or less, alternatively 0.7% or less, and alternatively 0.3% or less, and alternatively 0.3% to 0.8% of units containing hydroxyl groups, e.g., those represented by formula XSiO_{3/2} where R^{M} is as described above, and X represents a hydrolyzable substituent, e.g., OH. The concentration of silanol groups (where X=OH) present in the polyorganosilicate resin may be determined using FTIR spectroscopy and/or NMR as described above.

For use herein, the polyorganosilicate resin further comprises one or more terminal vinyl groups per molecule. The polyorganosilicate resin having terminal vinyl groups may be prepared by reacting the product of Daudt, et al. with a vinyl group-containing endblocking agent and an endblocking agent free of aliphatic unsaturation, in an amount sufficient to provide from 3 to 30 mole percent of vinyl groups in the final product. Examples of endblocking agents include, but are not limited to, silazanes, siloxanes, and silanes. Suitable endblocking agents are known in the art and exemplified in U.S. Pat. No. 4,584,355 to Blizzard, et al.; U.S. Pat. No. 4,591,622 to Blizzard, et al.; and U.S. Pat. No. 4,585,836 Homan, et al. A single endblocking agent or a mixture of such agents may be used to prepare such resin.

Alternatively, the polyorganosilicate resin may comprise unit formula (B2-17): (R²³₃SiO_{1/2})ₘₘ(R²³₂R^{A}SiO_{1/2})ₙₙ(SiO_{4/2})ₒₒ(ZO_{1/2})ₙ, where Z, R²³, and R^{A}, and subscript h are as described above and subscripts mm, nn and oo have average values such that mm≥0, nn>0, oo>0, and 0.5≤(mm+nn)/oo≤4. Alternatively, 0.6≤(mm+nn)/oo≤4; alternatively 0.7≤(mm+nn)/oo≤4, and alternatively 0.8≤(mm+nn)/oo≤4.

Alternatively, (B2) the vinyl-functional polyorganosiloxane may comprise (B2-18) a vinyl-functional silsesquioxane resin, i.e., a resin containing trifunctional (T) units of unit formula: (R²³₃SiO_{1/2})ₐ(R²³₂R^{A}SiO_{1/2})b(R²³₂SiO_{2/2})_{c}(R²³R^{A}SiO_{2/2})ₐ(R²³SiO_{3/2})ₑ(R^{A}SiO_{3/2})_{f}(ZO_{1/2})ₕ; where R²³ and R^{A} are as described above, subscript f>1, 2<(e+f)<10,000; 0<(a+b)/(e+f)<3; 0<(c+d)/(e+f)<3; and 0<h/(e+f)<1.5. Alternatively, the vinyl-functional silsesquioxane resin may comprise unit formula (B2-19): (R²³SiO_{3/2})ₑ(R^{A}SiO_{3/2})_{f}(ZO_{1/2})ₕ, where R²³, R^{A}, Z, and subscripts h, e and f are as described above. Alternatively, the vinyl-functional silsesquioxane resin may further comprise difunctional (D) units of formulae (R²³₂SiO_{2/2})_{c}(R²³R^{A}SiO_{2/2})_{d} in addition to the T units described above, i.e., a DT resin, where subscripts c and d are as described above. Alternatively, the vinyl-functional silsesquioxane resin may further comprise monofunctional (M) units of formulae (R²³₃SiO_{1/2})ₐ(R²³₂R^{A}SiO_{1/2}) b, i.e., an MDT resin, where subscripts a and b are as described above for unit formula (B2-1).

Vinyl-functional silsesquioxane resins are commercially available, for example. RMS-310, which comprises unit formula (B2-20): (Me₂ViSiO_{1/2})₂₅(PhSiO_{3/2})₇₅ dissolved in toluene, is commercially available from Dow Silicones Corporation of Midland, Michigan, USA. Vinyl-functional silsesquioxane resins may be produced by the hydrolysis and condensation or a mixture of trialkoxy silanes using the methods as set forth in “Chemistry and Technology of Silicone” by Noll, Academic Press, 1968, chapter 5, p 190-245. Alternatively, vinyl-functional silsesquioxane resins may be produced by the hydrolysis and condensation of a trichlorosilane using the methods as set forth in U.S. Pat. No. 6,281,285 to Becker, et al. and U.S. Pat. No. 5,010,159 to Bank, et al. Vinyl-functional silsesquioxane resins comprising D units may be prepared by known methods, such as those disclosed in U.S. Patent Application 2020/0140619 and PCT Publication WO2018/204068 to Swier, et al.

Alternatively, starting material (B) the vinyl-functional organosilicon compound may comprise (B3) a vinyl-functional silazane. The vinyl-functional silazane may have formula (B3-1): [(R³² _{(3-gg)}R^{A}_{gg}Si)_{ff}NH_{(3-ff)}]ₕₕ, where R^{A} is as described above; each R³² is independently selected from the group consisting of an alkyl group and an aryl group; each subscript ff is independently 1 or 2; and subscript gg is independently 0, 1, or 2; where 1>hh>10. For R³², the alkyl group and the aryl group may be the alkyl group and the aryl group as described above for R²³. Alternatively, subscript hh may have a value such that 1>hh>6. Examples of vinyl-functional silazanes include, MePhViSiNH₂, Me₂ViSiNH₂, (ViMe₂Si)₂NH, (MePhViSi)₂NH. Vinyl-functional silazanes may be prepared by known methods, for example, reacting a vinyl-functional halosilane with ammonia under anhydrous or substantially anhydrous conditions, and thereafter distilling the resulting reaction mixture to separate cyclic vinyl-functional silazanes and linear vinyl-functional silazanes, such as those disclosed in U.S. Pat. No. 2,462,635 to Haber; U.S. Pat. No. 3,243,404 to Martellock; and PCT Publication No. WO83/02948 to Dziark. Suitable vinyl-functional silazanes are commercially available, for example, 2,4,6-trimethyl-2,4,6-trivinylcyclotrisilazane (MeViSiNH)₃ is available from Sigma-Aldrich of St. Louis, MO, USA; sym-tetramethyldivinyldisilazane (ViMe₂Si)₂NH is available from Alfa Aesar; and 1,3-divinyl-1,3-diphenyl-1,3-dimethyldisilazane (MePhViSi)₂NH is available from Gelest, Inc. of Morrisville, Pennsylvania, USA.

Starting material (B) may be any one of the vinyl-functional organosilicon compounds described above. Alternatively, starting material (B) may comprise a mixture of two or more of the vinyl-functional organosilicon compounds.

Starting material (C), the hydroformylation reaction catalyst for use herein comprises an activated complex of rhodium and a ligand. The ligand may be symmetric or asymmetric. Alternatively, the ligand may be symmetric. In one embodiment, the ligand comprises, alternatively is, a bisphosphoramidite ligand. In other embodiments, the ligand comprises, alternatively is, a tetraphosphoramidite ligand. In yet other embodiments, the ligand comprises, alternatively is, a phosphine amine ligand. Further still, in other embodiments, the ligand comprises, alternatively is, a phosphine ligand. In yet other embodiments, starting material (C) may comprise a blend of rhodium/ligand complexes including different species of ligands.

The ligand has formula (C1), (C2), and/or (C3):

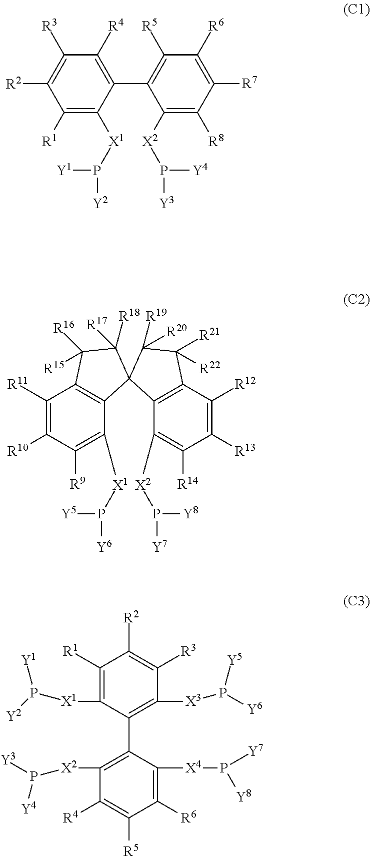

where: R¹-R²² are each independently selected from hydrogen, a hydrocarbyl group, a heteroaryl group, a halogen atom, or a heterocarbyl group, wherein two or more of R¹-R²² may optionally be bonded together to give one or more cyclic moieties; each of X¹-X⁴ is independently selected from O, CH₂, NH, NR, NSO₂R or NSO₂A, where each R is an independently selected substituted or unsubstituted alkyl or aryl group and each A is an independently selected aryl or heteroaryl group; and each of Y¹-Y⁸ is an independently selected nitrogen-containing heterocyclic moiety bonded to P via N, wherein each heterocyclic moiety may be substituted with one or more groups or atoms selected from alkyl, aryl, heteroaryl, alkoxy, acyl, carboxyl, carboxylate, cyano, —SO₃H, sulfonate, amino, trifluoromethyl, and halogen.

In one embodiment, the ligand has formula (C1). In another embodiment, the ligand has formula (C2). In yet another embodiment, the ligand has formula (C3).

Suitable hydrocarbyl groups for R¹-R²² may independently be linear, branched, cyclic, or combinations thereof. Cyclic hydrocarbyl groups encompass aryl groups as well as saturated or non-conjugated cyclic groups. Cyclic hydrocarbyl groups may be monocyclic or polycyclic. Linear and branched hydrocarbyl groups may independently be saturated or unsaturated. One example of a combination of a linear and cyclic hydrocarbyl group is an aralkyl group. By “substituted,” it is meant that one or more hydrogen atoms may be replaced with atoms other than hydrogen (e.g. a halogen atom, such as chlorine, fluorine, bromine, etc.). Suitable alkyl groups are exemplified by, but not limited to, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, as well as branched saturated hydrocarbon groups of 6 carbon atoms. Suitable aryl groups are exemplified by, but not limited to, phenyl, tolyl, xylyl, naphthyl, benzyl, and dimethyl phenyl. Suitable alkenyl groups include vinyl, allyl, propenyl, isopropenyl, butenyl, isobutenyl, pentenyl, heptenyl, hexenyl, and cyclohexenyl groups. Suitable monovalent halogenated hydrocarbon groups include, but are not limited to, a halogenated alkyl group of 1 to 6 carbon atoms, or a halogenated aryl group of 6 to 10 carbon atoms. Suitable halogenated alkyl groups are exemplified by, but not limited to, the alkyl groups described above where one or more hydrogen atoms is replaced with a halogen atom, such as F or Cl. For example, fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl are examples of suitable halogenated alkyl groups. Suitable halogenated aryl groups are exemplified by, but not limited to, the aryl groups described above where one or more hydrogen atoms is replaced with a halogen atom, such as F or Cl. For example, chlorobenzyl and fluorobenzyl are suitable halogenated aryl groups. Suitable heterocarbyl groups include any of the hydrocarbyl groups described above, but including one or more heteroatoms, such as oxygen, sulfur, nitrogen, etc. Suitable halogen atoms include F, Cl, Br, I, At, and Ts, alternatively F, Cl, and Br, alternatively Cl.

As described above, two or more of R¹-R²² may optionally be bonded together to give one or more cyclic moieties. The cyclic moieties formed by a combination of any of R¹-R²² may be aliphatic or aromatic, and may be monocyclic, bicyclic, or polycyclic.

By way of example, when the ligand has formula (C1), when R¹, R², R⁷, and R⁸ are each H, and R³ and R⁴ form an aliphatic cyclic ring, and R⁵ and R⁶ together form an aliphatic cyclic ring, the ligand of formula (C1) becomes the following:

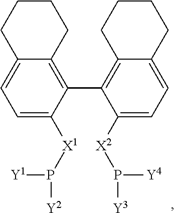

Where X¹, X², and Y¹-Y⁴ are defined above.

As another example, when the ligand has formula (C1), when R¹, R², R⁷, and R⁸ are each H, and R³ and R⁴ form an aromatic ring, and R⁵ and R⁶ together form an aromatic cyclic ring, the ligand of formula (C1) becomes the following:

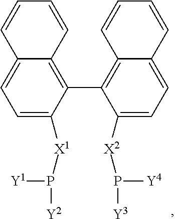

Where X¹, X², and Y¹-Y⁴ are defined above.

As yet another example, when the ligand has formula (C1), when R³, R⁴, R⁵, and R⁶ are each H, and R¹ and R² form a bicyclic aromatic structure, and R⁷ and R⁸ together form a bicyclic aromatic structure, the ligand of formula (C1) becomes the following:

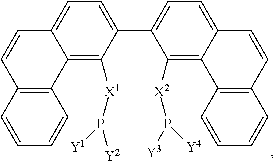

Where X¹, X², and Y¹-Y⁴ are defined above.

Each of X¹-X⁴ is independently selected from O, CH₂, NH, NR, NSO₂R or NSO₂A, where each R is an independently selected substituted or unsubstituted alkyl or aryl group and each A is an independently selected aryl or heteroaryl group. In certain embodiments, each of X¹-X⁴ is O.

Each of Y¹-Y⁸ is an independently selected nitrogen-containing heterocyclic moiety bonded to P via N, wherein each heterocyclic moiety may be substituted with one or more groups or atoms selected from alkyl, aryl, heteroaryl, alkoxy, acyl, carboxyl, carboxylate, cyano, —SO₃H, sulfonate, amino, trifluoromethyl, and halogen. Each of Y¹-Y⁸ may independently be monocyclic, bicyclic, and/or polycyclic. Exemplary examples of nitrogen-containing heterocyclic groups include indole groups, isoindole groups, pyrrole groups, carbazole groups, and imidazole groups. As noted above, any of the carbon atoms in these groups can be substituted with one or more groups or atoms selected from alkyl, aryl, heteroaryl, alkoxy, acyl, carboxyl, carboxylate, cyano, —SO₃H, sulfonate, amino, trifluoromethyl, and halogen. In specific embodiments, at least one of Y¹-Y⁸ is substituted with an alkoxy group having from 1 to 8 carbon atoms. In these or other embodiments, at least one of Y¹-Y⁸ is substituted with an alkyl group having from 1 to 12 carbon atom, e.g. tert-butyl groups.

In certain embodiments, the ligand has formula (C1), and R¹-R⁸, X¹-X², and Y¹-Y⁴ are selected such that the ligand is a bisphosphoramidite ligand having one of the following formulas (where Me indicates methyl and tBu indicates t-butyl):

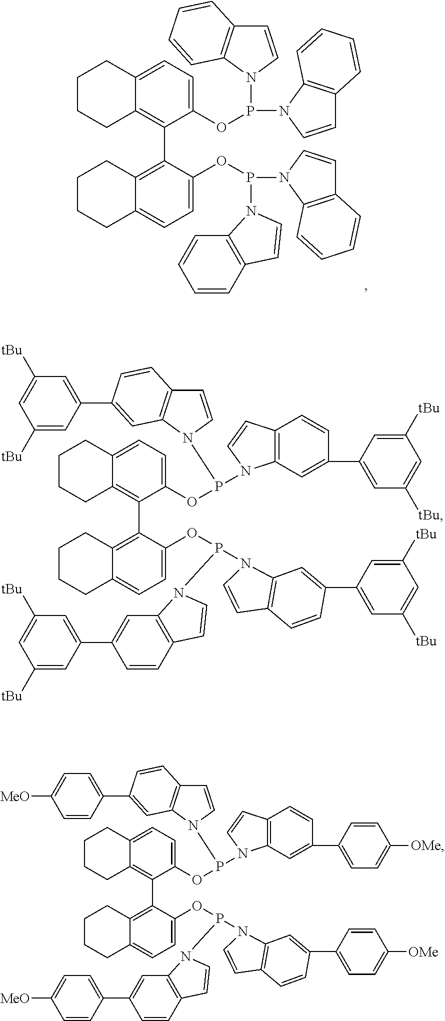 [SMILES: c1ccc2c(c1)ccn2P(Oc1ccc2c(c1-c1c(OP(n3ccc4ccccc43)n3ccc4ccccc43)ccc3c1CCCC3)CCCC2)n1ccc2ccccc21 ; CC(C)(C)c1cc(-c2ccc3ccn(P(Oc4ccc5c(c4-c4c(OP(n6ccc7ccc(-c8cc(C(C)(C)C)cc(C(C)(C)C)c8)cc76)n6ccc7ccc(-c8cc(C(C)(C)C)cc(C(C)(C)C)c8)cc76)ccc6c4CCCC6)CCCC5)n4ccc5ccc(-c6cc(C(C)(C)C)cc(C(C)(C)C)c6)cc54)c3c2)cc(C(C)(C)C)c1 ; COc1ccc(-c2ccc3ccn(P(Oc4ccc5c(c4-c4c(OP(n6ccc7ccc(-c8ccc(OC)cc8)cc76)n6ccc7ccc(-c8ccc(OC)cc8)cc76)ccc6c4CCCC6)CCCC5)n4ccc5ccc(-c6ccc(OC)cc6)cc54)c3c2)cc1]

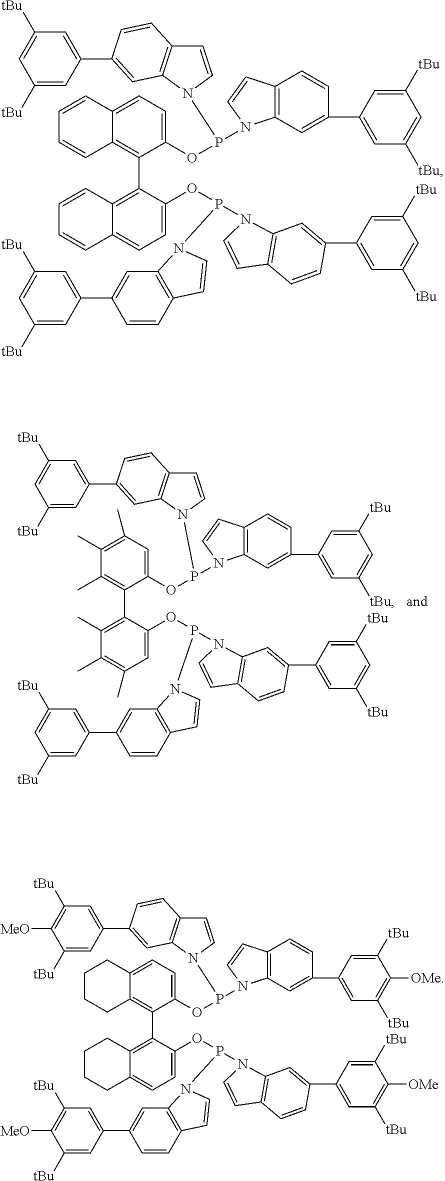

Methods of preparing the first ligand structure above in this section for formula (C1) are disclosed in U.S. Pat. No. 9,795,952 to Diebolt et al, which is incorporated by reference herein in its entirety.

In other embodiments, the ligand has formula (C2), and R⁹-R²², X¹-X², and Y⁵-Y⁸ are selected such that the ligand is a bisphosphoramidite ligand having one of the following formulas:

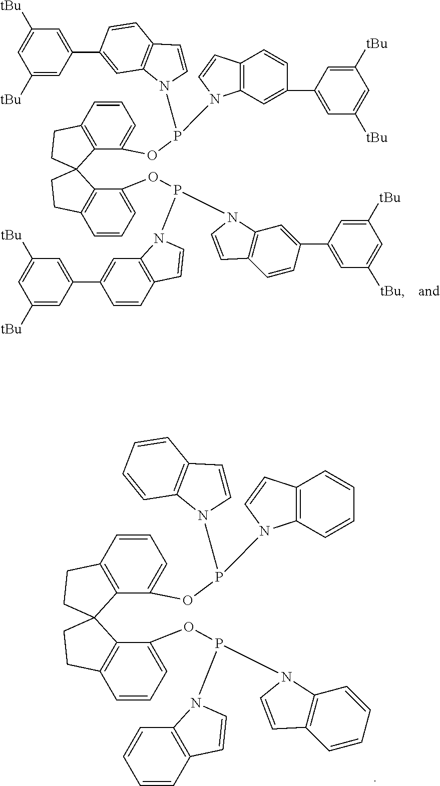 [SMILES: CC(C)(C)c1cc(-c2ccc3ccn(P(Oc4cccc5c4C4(CC5)CCc5cccc(OP(n6ccc7ccc(-c8cc(C(C)(C)C)cc(C(C)(C)C)c8)cc76)n6ccc7ccc(-c8cc(C(C)(C)C)cc(C(C)(C)C)c8)cc76)c54)n4ccc5ccc(-c6cc(C(C)(C)C)cc(C(C)(C)C)c6)cc54)c3c2)cc(C(C)(C)C)c1 ; c1cc2c(c(OP(n3ccc4ccccc43)n3ccc4ccccc43)c1)C1(CC2)CCc2cccc(OP(n3ccc4ccccc43)n3ccc4ccccc43)c21]

In yet other embodiments, the ligand has formula (C3), and R¹-R⁶, X¹-X⁴, and Y¹-Y⁸ are selected such that the ligand is a tetraphosphoramidite ligand having one of the following formulas:

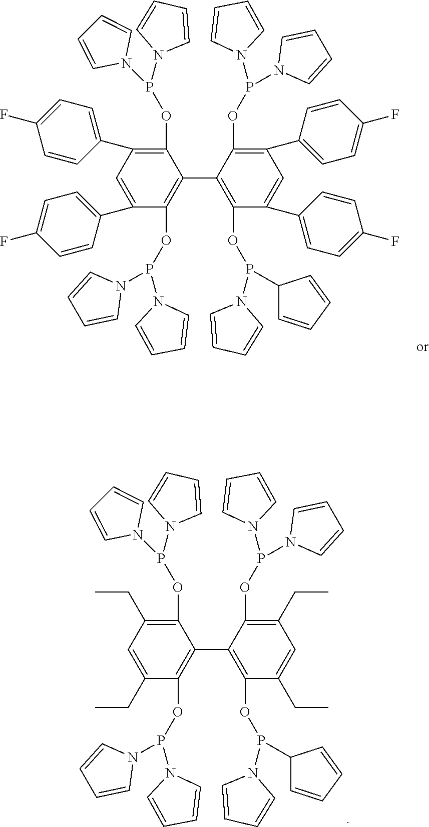 [SMILES: Fc1ccc(-c2cc(-c3ccc(F)cc3)c(OP(n3cccc3)n3cccc3)c(-c3c(OP(n4cccc4)n4cccc4)c(-c4ccc(F)cc4)cc(-c4ccc(F)cc4)c3OP(n3cccc3)n3cccc3)c2OP(C2C=CC=C2)n2cccc2)cc1 ; CCc1cc(CC)c(OP(n2cccc2)n2cccc2)c(-c2c(OP(n3cccc3)n3cccc3)c(CC)cc(CC)c2OP(n2cccc2)n2cccc2)c1OP(C1C=CC=C1)n1cccc1]

Methods of preparing these ligand structures above in this section for formula (C3) are disclosed in U.S. Pat. No. 7,531,698 to Zhang et al, which is incorporated by reference herein in its entirety.

Starting material (C), the rhodium/ligand complex catalyst, may be prepared by methods known in the art, such as those disclosed in U.S. Pat. No. 4,769,498 to Billig, et al. at col. 20, line 50-col. 21, line 40 and U.S. Pat. No. 10,023,516 to Brammer et al. col. 11, line 35-col. 12, line 12 by varying appropriate starting materials. For example, the rhodium/ligand complex catalyst may be prepared by a process comprising combining a rhodium precursor and the ligand described above under conditions to form the complex, which complex may then be introduced into a hydroformylation reaction medium comprising one or both of starting materials (A) and/or (B), described above. Alternatively, the rhodium/ligand complex catalyst may be formed in situ by introducing the rhodium catalyst precursor into the reaction medium, and the ligand into the reaction medium (e.g., before, during, and/or after introduction of the rhodium catalyst precursor), for the in situ formation of the rhodium/ligand complex catalyst.

The rhodium/ligand complex catalyst can be activated by heating and/or exposure to starting material (A) to form the (C) rhodium/ligand complex catalyst. Rhodium catalyst precursors are exemplified by rhodium dicarbonyl acetylacetonate, Rh₂O₃, Rh₄(CO)₁₂, Rh₆(CO)₁₆, and Rh(NO₃)₃. Additional methods to prepare certain ligands are described herein in the appended Examples.

For example, a rhodium precursor, such as rhodium dicarbonyl acetylacetonate, optionally starting material (D), a solvent, and the ligand may be combined, e.g., by any convenient means such as mixing. The resulting rhodium/ligand complex catalyst may be introduced into the reactor, optionally with excess ligand. Alternatively, the rhodium precursor, (D) the solvent, and the ligand may be combined in the reactor with starting material (A) and/or (B), the vinyl-functional organosilicon compound; and the rhodium/ligand complex may form in situ. The relative amounts of ligand and rhodium precursor are sufficient to provide a molar ratio of ligand/Rh of 10/1 to 1/1, alternatively 5/1 to 1/1, alternatively 3/1 to 1/1, alternatively 2.5/1 to 1.5/1. In addition to the rhodium/ligand complex catalyst, excess (e.g., not complexed) ligand may be present in the reaction mixture. The excess ligand may be the same as, or different from, the ligand in the rhodium/ligand complex catalyst.

The amount of (C) the rhodium/ligand complex catalyst (catalyst) is sufficient to catalyze hydroformylation of (B) the vinyl-functional organosilicon compound. The exact amount of catalyst will depend on various factors including the type of vinyl-functional organosilicon compound selected for starting material (B), its exact vinyl content, and the reaction conditions such as temperature and pressure of starting material (A). However, the amount of (C) the catalyst may be sufficient to provide a rhodium metal concentration of at least 0.1 ppm, alternatively 0.15 ppm, alternatively 0.2 ppm, alternatively 0.25 ppm, and alternatively 0.5 ppm, based on the weight of (B) the vinyl-functional organosilicon compound. At the same time, the amount of (C) the catalyst may be sufficient to provide a rhodium metal concentration of up to 300 ppm, alternatively up to 100 ppm, alternatively up to 20 ppm, and alternatively up to 5 ppm, on the same basis. Alternatively, the amount of (C) the catalyst may be sufficient to provide 0.1 ppm to 300 ppm, alternatively 0.2 ppm to 100 ppm, alternatively, 0.25 ppm to 20 ppm, and alternatively 0.5 ppm to 5 ppm, based on the weight of (B) the vinyl-functional organosilicon compound.

The hydroformylation process reaction may run without additional solvents. Alternatively, the hydroformylation process reaction may be carried out with a solvent, for example to facilitate mixing and/or delivery of one or more of the starting materials described above, such as the (C) catalyst and/or starting material (B), when a solvent such as a vinyl-functional polyorganosilicate resin is selected for starting material (B). The solvent is exemplified by aliphatic or aromatic hydrocarbons, which can dissolve the starting materials, e.g., toluene, xylene, benzene, hexane, heptane, decane, cyclohexane, or a combination of two or more thereof. Additional solvents include THF, dibutyl ether, diglyme, and Texanol. Without wishing to be bound by theory, it is thought that solvent may be used to reduce the viscosity of the starting materials. The amount of solvent is not critical, however, when present, the amount of solvent may be 5% to 70% based on weight of starting material (B) the vinyl-functional organosilicon compound.

In the process described herein, step 1) is performed at relatively low temperature. For example, step 1) may be performed at a temperature of at least 30° C., alternatively at least 50° C., and alternatively at least 70° C. At the same time, the temperature in step 1) may be up to 150° C.; alternatively up to 100° C.; alternatively up to 90° C., and alternatively up to 80° C. Without wishing to be bound by theory, it is thought that lower temperatures, e.g., 30° C. to 90° C., alternatively 40° C. to 90° C., alternatively 50° C. to 90° C., alternatively 60° C. to 90° C., alternatively 70° C. to 90° C., alternatively 80° C. to 90° C., alternatively 30° C. to 60° C., alternatively 50° C. to 60° C. may be desired for achieving high selectivity and ligand stability.

In the process described herein, step 1) may be performed at a pressure of at least 101 kPa (ambient), alternatively at least 206 kPa (30 psi), and alternatively at least 344 kPa (50 psi). At the same time, pressure in step 1) may be up to 6,895 kPa (1,000 psi), alternatively up to 1,379 kPa (200 psi), alternatively up to 1000 kPa (145 psi), and alternatively up to 689 kPa (100 psi). Alternatively, step 1) may be performed at 101 kPa to 6,895 kPa; alternatively 344 kPa to 1,379 kPa; alternatively 101 kPa to 1,000 kPa; and alternatively 344 kPa to 689 kPa. Without wishing to be bound by theory, it is thought that using relatively low pressures, e.g., < to 6,895 kPa in the process herein may be beneficial; the ligands described herein allow for low pressure hydroformylation processes, which have the benefits of lower cost and better safety than high pressure hydroformylation processes.

The hydroformylation process may be carried out in a batch, semi-batch, or continuous mode, using one or more suitable reactors, such as a fixed bed reactor, a fluid bed reactor, a continuous stirred tank reactor (CSTR), or a slurry reactor. The selection of (B) the vinyl-functional organosilicon compound, and (C) the catalyst, and whether (D) the solvent, is used may impact the size and type of reactor used. One reactor, or two or more different reactors, may be used. The hydroformylation process may be conducted in one or more steps, which may be affected by balancing capital costs and achieving high catalyst selectivity, activity, lifetime, and ease of operability, as well as the reactivity of the particular starting materials and reaction conditions selected, and the desired product.

Alternatively, the hydroformylation process may be performed in a continuous manner. For example, the process used may be as described in U.S. Pat. No. 10,023,516 except that the olefin feed stream and catalyst described therein are replaced with (B) the vinyl-functional organosilicon compound and (C) the rhodium/ligand complex catalyst, each described herein.

Step 1) of the hydroformylation process forms a reaction fluid comprising the aldehyde-functional organosilicon compound. The reaction fluid may further comprise additional materials, such as those which have either been deliberately employed, or formed in situ, during step 1) of the process. Examples of such materials that can also be present include unreacted (B) vinyl-functional organosilicon compound, unreacted (A) carbon monoxide and hydrogen gases, and/or in situ formed side products, such as ligand degradation products and adducts thereof, and high boiling liquid aldehyde condensation byproducts, as well as (D) a solvent, if employed. The term “ligand degradation product” includes but is not limited to any and all compounds resulting from one or more chemical transformations of at least one of the ligand molecules used in the process.

The hydroformylation process may further comprise one or more additional steps such as: 2) recovering (C) the rhodium/ligand complex catalyst from the reaction fluid comprising the aldehyde-functional organosilicon compound. Recovering (C) the rhodium/ligand complex catalyst may be performed by methods known in the art, including but not limited to adsorption and/or membrane separation (e.g., nanofiltration). Suitable recovery methods are as described, for example, in U.S. Pat. No. 5,681,473 to Miller, et al.; U.S. Pat. No. 8,748,643 to Priske, et al.; and 10,155,200 to Geilen, et al.

However, one benefit of the process described herein is that (C) the catalyst need not be removed and recycled. Due to the low level of Rh needed, it may be more cost effective not to recover and recycle (C) the catalyst; and the aldehyde-functional organosilicon compound produced by the process may be stable even when the catalyst is not removed. Therefore, alternatively, the process described above may be performed without step 2).

Alternatively, the hydroformylation process may further comprise 3) purification of the reaction product. For example, the aldehyde-functional organosilicon compound may be isolated from the additional materials, described above, by any convenient means such as stripping and/or distillation, optionally with reduced pressure.

### EXAMPLES

These examples are provided to illustrate the invention to one of ordinary skill in the art and should not be construed to limit the scope of the invention set forth in the claims. Starting materials used herein are described in Table 1, below.

The following examples are intended to illustrate the invention and are not to be viewed in any way as limiting to the scope of the invention.

Certain components utilized in the Examples are set forth in Table 1 below.

TABLE 1
Components/Compounds Utilized

| Component | Chemical Class/Description |
|---|---|
| Solvent 1 | Toluene (C₇H₈) |
| Solvent 2 | Hexane (C₆H₁₄) |
| Substrate 1 | Bis-dimethylvinylsiloxy-terminated polydimethylsiloxane homopolymer with |
| | Mn = 11,500 g/mol (M^{Vi}D₁₇₈M^{Vi}) |
| Substrate 2 | Bis-dimethylvinylsiloxy-terminated polydimethylsiloxane homopolymer with an |
| | average of 7 dimethylsiloxy (D) units per molecule (M^{Vi}D₇M^{Vi}) |
| Substrate 3 | Bis-dimethylvinylsiloxy-terminated poly(dimethyl/methylvinyl)siloxane |
| | copolymer with an average of 543 dimethylsiloxy (D) units and 147 |
| | methylvinylsiloxy (D^{Vi}) units per molecule (M^{Vi}D₅₄₃D^{Vi}₁₄₇M^{Vi}) |
| Substrate 4 | Bis-dimethylvinylsiloxy-terminated poly(dimethyl/methylvinyl)siloxane |
| | copolymer with an average of 141 dimethylsiloxy (D) units and 2 |
| | methylvinylsiloxy (D^{Vi}) units per molecule (M^{Vi}D₁₄₁D^{Vi}₂M^{Vi}) |
| Substrate 5 | 5-((1,1,1,3,5,5,5-heptamethyltrisiloxan-3-yl)oxy)-1,1, 1,3,7,9,9,9-octamethyl- |
| | 3,7-bis((trimethylsilyl)oxy)-5-vinylpenta-siloxane |
| | 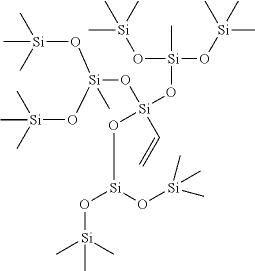 |
| Substrate 6 | 1,3-diviny1, 1,3,3-tetramethydisiloxane (M^{Vi}M^{Vi}) |
| Substrate 7 | 1,1,1,3,5,5,5-heptamethyl-3-vinyltrisiloxane (MD^{Vi}M) |
| Substrate 8 | Vinyltrimethylsilane (ViSiMe₃) |
| Substrate 9 | Methyl- and vinyl-functional polyorganosilicate resin with an average of 40 |
| | trimethylsiloxy (M) units, 4 dimethylvinylsiloxy (M^{Vi}) units and 56 tetrasiloxy |
| | units per molecule ((Me₃SiO_{1/2})₄₀(Me₂ViSiO_{1/2})₄(SiO_{4/2})₅₆) |
| Substrate 10 | Silsesquioxane resin with methyl, vinyl, and phenyl groups with an average of |
| | 25 dimethylvinylsiloxy (M^{Vi}) units and 75 phenylsiloxy (T^{Ph}) units per molecule |
| | (63.7 wt. % solution of (Me₂ViSiO_{1/2})₂₅(PhSiO_{3/2})₇₅ in toluene) |
| Catalyst | Rh(acac)(CO)₂, where acac refers to acetylacetonyl |
| Precursor | |
| Precatalyst | 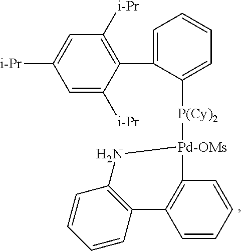 |
| | obtained from from Sigma-Aldrich as |
| | XPhos Pd G3 |
| Comparative | Triphenylphosphine |
| Ligand 1 | |
| Comparative | Tri-tert-butylphosphine |
| Ligand 2 | |
| Comparative Ligand 3 | 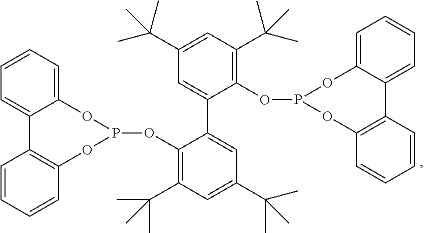 [SMILES: CC(C)(C)c1cc(-c2cc(C(C)(C)C)cc(C(C)(C)C)c2Op2oc3ccccc3c3ccccc3o2)c(Op2oc3ccccc3c3ccccc3o2)c(C(C)(C)C)c1] |
| | as prepared in accordance with the disclosure of U.S. Pat. No. 8,546,600 to |
| | Miller. |
| Ligand 1 | 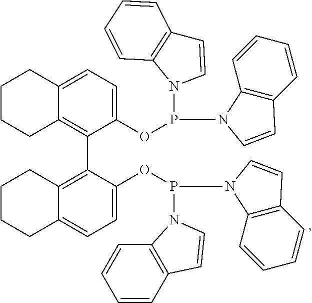 [SMILES: c1ccc2c(c1)ccn2P(Oc1ccc2c(c1-c1c(OP(n3ccc4ccccc43)n3ccc4ccccc43)ccc3c1CCCC3)CCCC2)n1ccc2ccccc21] |
| | as prepared in accordance |
| | with the disclosure of U.S. Pat. No. 9,795,952 to Diebolt et al. |
| Ligand 2 | 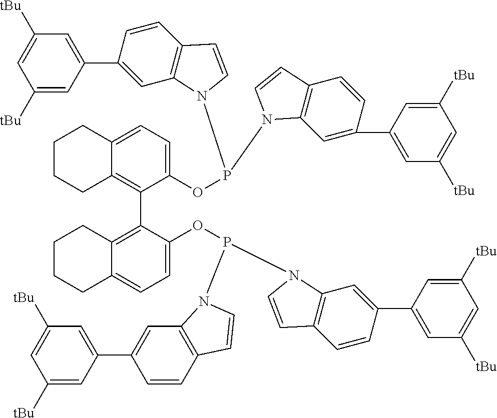 [SMILES: CC(C)(C)c1cc(-c2ccc3ccn(P(Oc4ccc5c(c4-c4c(OP(n6ccc7ccc(-c8cc(C(C)(C)C)cc(C(C)(C)C)c8)cc76)n6ccc7ccc(-c8cc(C(C)(C)C)cc(C(C)(C)C)c8)cc76)ccc6c4CCCC6)CCCC5)n4ccc5ccc(-c6cc(C(C)(C)C)cc(C(C)(C)C)c6)cc54)c3c2)cc(C(C)(C)C)c1] |
| Ligand 3 | 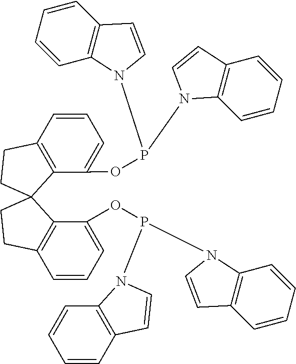 [SMILES: c1cc2c(c(OP(n3ccc4ccccc43)n3ccc4ccccc43)c1)C1(CC2)CCc2cccc(OP(n3ccc4ccccc43)n3ccc4ccccc43)c21] |
| Ligand 4 | 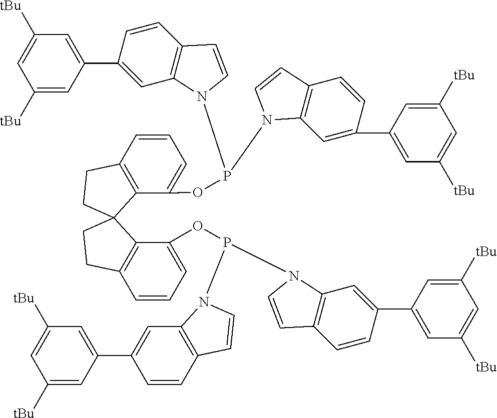 [SMILES: CC(C)(C)c1cc(-c2ccc3ccn(P(Oc4cccc5c4C4(CC5)CCc5cccc(OP(n6ccc7ccc(-c8cc(C(C)(C)C)cc(C(C)(C)C)c8)cc76)n6ccc7ccc(-c8cc(C(C)(C)C)cc(C(C)(C)C)c8)cc76)c54)n4ccc5ccc(-c6cc(C(C)(C)C)cc(C(C)(C)C)c6)cc54)c3c2)cc(C(C)(C)C)c1] |
| Ligand 5 | 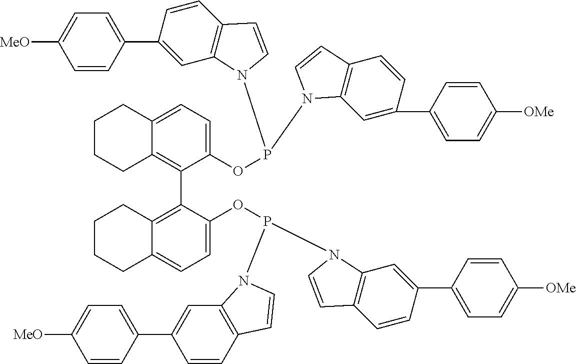 [SMILES: COc1ccc(-c2ccc3ccn(P(Oc4ccc5c(c4-c4c(OP(n6ccc7ccc(-c8ccc(OC)cc8)cc76)n6ccc7ccc(-c8ccc(OC)cc8)cc76)ccc6c4CCCC6)CCCC5)n4ccc5ccc(-c6ccc(OC)cc6)cc54)c3c2)cc1] |
| Ligand 6 | 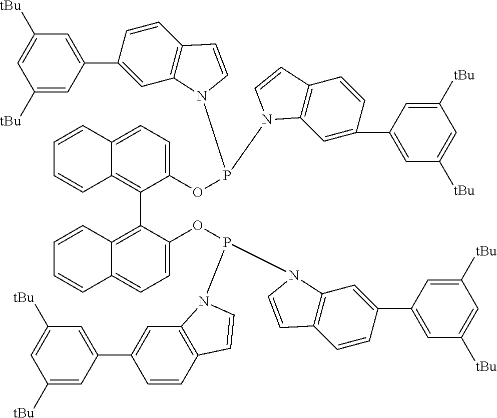 [SMILES: CC(C)(C)c1cc(-c2ccc3ccn(P(Oc4ccc5ccccc5c4-c4c(OP(n5ccc6ccc(-c7cc(C(C)(C)C)cc(C(C)(C)C)c7)cc65)n5ccc6ccc(-c7cc(C(C)(C)C)cc(C(C)(C)C)c7)cc65)ccc5ccccc45)n4ccc5ccc(-c6cc(C(C)(C)C)cc(C(C)(C)C)c6)cc54)c3c2)cc(C(C)(C)C)c1] |
| Ligand 7 | 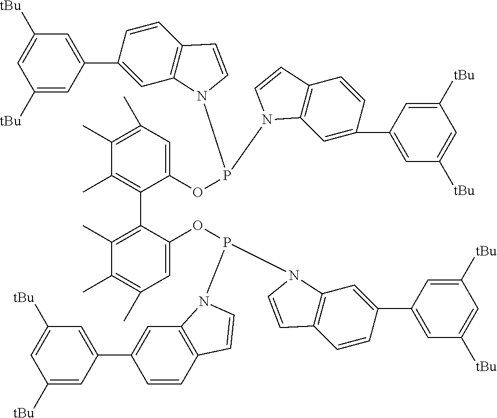 [SMILES: Cc1cc(OP(n2ccc3ccc(-c4cc(C(C)(C)C)cc(C(C)(C)C)c4)cc32)n2ccc3ccc(-c4cc(C(C)(C)C)cc(C(C)(C)C)c4)cc32)c(-c2c(OP(n3ccc4ccc(-c5cc(C(C)(C)C)cc(C(C)(C)C)c5)cc43)n3ccc4ccc(-c5cc(C(C)(C)C)cc(C(C)(C)C)c5)cc43)cc(C)c(C)c2C)c(C)c1C] |
| Ligand 8 | 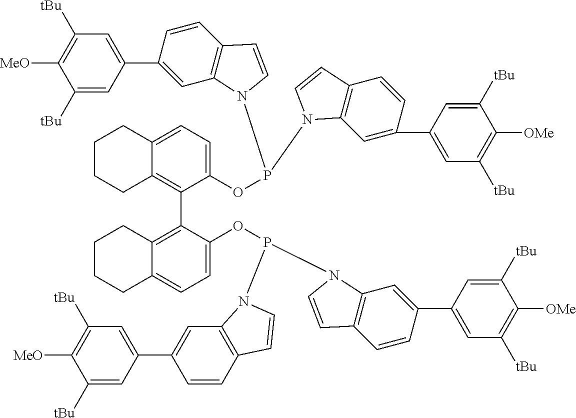 [SMILES: COc1c(C(C)(C)C)cc(-c2ccc3ccn(P(Oc4ccc5c(c4-c4c(OP(n6ccc7ccc(-c8cc(C(C)(C)C)c(OC)c(C(C)(C)C)c8)cc76)n6ccc7ccc(-c8cc(C(C)(C)C)c(OC)c(C(C)(C)C)c8)cc76)ccc6c4CCCC6)CCCC5)n4ccc5ccc(-c6cc(C(C)(C)C)c(OC)c(C(C)(C)C)c6)cc54)c3c2)cc1C(C)(C)C] |
| Ligand 9 | 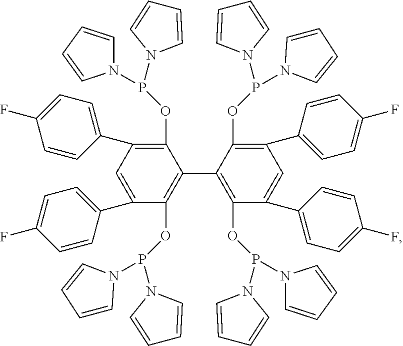 [SMILES: Fc1ccc(-c2cc(-c3ccc(F)cc3)c(OP(n3cccc3)n3cccc3)c(-c3c(OP(n4cccc4)n4cccc4)c(-c4ccc(F)cc4)cc(-c4ccc(F)cc4)c3OP(n3cccc3)n3cccc3)c2OP(n2cccc2)n2cccc2)cc1] |
| | as prepared in |
| | U.S. Pat. No. 7,531,698 to Zhang et al. |
| Ligand 10 | 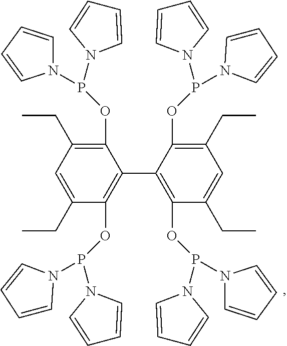 [SMILES: CCc1cc(CC)c(OP(n2cccc2)n2cccc2)c(-c2c(OP(n3cccc3)n3cccc3)c(CC)cc(CC)c2OP(n2cccc2)n2cccc2)c1OP(n1cccc1)n1cccc1] |
| | as prepared in U.S. Pat. No. |
| | 7,531,698 to Zhang et al. |

The product structures and composition were supported by ¹H, ¹³C, and ²⁹Si Nuclear Magnetic Resonance (NMR).

¹H, ¹³C, and ²⁹Si NMR spectra were recorded on a Varian 400-NMR spectrometer (400 MHz, 1H) with an autosampler. Chemical shifts (δ) for ¹H and ¹³C spectra were referenced to internal solvent resonances and are reported relative to tetramethyl silane. Predicted chemical shifts for ¹H and ¹³C spectra were obtained using Perkin-Elmer ChemDraw Version 18.2.0.48 software.

### Preparation Examples: Ligand Synthesis

Unless otherwise mentioned, all solvents and reagents were obtained from commercial sources and used as received. Anhydrous toluene, hexanes, tetrahydrofuran, and diethyl ether were purified via passage through activated alumina. Solvents used for experiments performed in a nitrogen-filled glovebox were further dried by storage over activated 3 Å molecular sieves. Glassware for moisture-sensitive reactions was dried in an oven (120° C.) overnight prior to use. NMR spectra were recorded on a Bruker 400-MHz spectrometer. LC-MS analyses were performed using a Waters e2695 Separations Module coupled with a Waters 2424 ELS detector, a Waters 2998 PDA detector, and a Waters 3100 ESI mass detector. LC-MS separations were performed on an XBridge C18 3.5 μm 2.1×50 mm column using a 5:95 to 100:0 acetonitrile to water gradient with 0.1% formic acid as the ionizing agent. HRMS analyses were performed using an Agilent 1290 Infinity LC with a Zorbax Eclipse Plus C18 1.8 μm 2.1×50 mm column, coupled with an Agilent 6230 TOF Mass Spectrometer with electrospray ionization. 1H NMR data are reported as follows: chemical shift (multiplicity (br=broad, s=singlet, d=doublet, t=triplet, q=quartet, p=pentet, sex=sextet, sept=septet and m=multiplet), integration, and assignment). Chemical shifts for ¹H NMR data are reported in ppm in the deuterated solvent as references. ¹³C NMR data were determined with ¹H decoupling, and the chemical shifts are reported in ppm relative to tetramethylsilane (TMS, δ scale) using residual carbons in the deuterated solvent as references. Chemical shifts for ³¹P NMR data chemical shifts are reported in ppm (referenced with respect to H₃PO₄).

### Preparation Example 1: Ligand 2

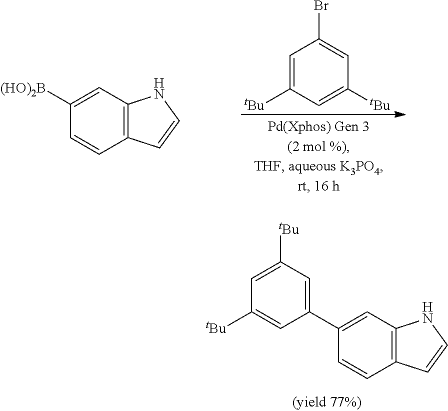 [SMILES: OB(O)c1ccc2cc[nH]c2c1 ; CC(C)(C)c1cc(Br)cc(C(C)(C)C)c1 ; CC(C)(C)c1cc(-c2ccc3cc[nH]c3c2)cc(C(C)(C)C)c1]

A 3-neck 2-L round bottom flask was charged with 25 g (155.3 mmol) of 1H-indole-6-boronic acid, 2.7 g (3.1 mmol) of Precatalyst, and 500 mL of THF to give a mixture. The mixture was stirred at room temperature. After 5 minutes, 41.2 g (170.8 mmol) of 1-bromo-3,5-di-tert-butylbenzene was added to the mixture, followed by approximately 600 mL of an aqueous solution of potassium phosphate tribasic (99 g, 466 mmol in 600 mL of H₂O) to give a reaction mixture. The reaction mixture was then stirred at room temperature overnight. The next morning, an aliquot was removed and analyzed by UP-LC which showed complete consumption of starting material. Diethyl ether (400 mL) was added, and the mixture was then transferred to a separatory funnel. The organic layer was separated, and the aqueous layer was further washed with 200 mL of diethyl ether (2×). The organic layers were combined and dried over anhydrous MgSO₄. The solvent was removed under reduced pressure to yield a brownish solid. Next, the material was dissolved in diethyl ether and treated with activated carbon for decolorization. The product was filtered through a Celite™ pad and concentrated down to yield brownish solid. The solid was purified by a trituration procedure.

Trituration Procedure: Hexane (300 mL, ˜10 mL/g crude material) was added to the crude material (solid) formed above to give a mixture. The mixture was heated in a water bath (55° C.) for 15 mins to dissolve non-polar impurities and the mixture was quickly filtered with a frit filter to collect the pure product. Following the first trituration, 23.0 g of pure product was isolated as white powder. The filtrate from the first trituration was concentrated on a rotary evaporator to leave a solid residue which was purified by silica gel column chromatography using hexane:ethyl acetate as eluent to yield a second batch of the product (7.5 g) as a white solid. The product here was 6-(3,5-di-tert-butylphenyl)-1H-indole.

Next, bis(indolyl)chlorophosphine was prepared from the 6-(3,5-di-tert-butylphenyl)-1H-indole:

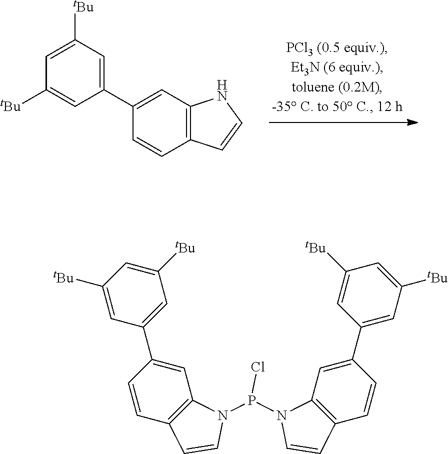 [SMILES: CC(C)(C)c1cc(-c2ccc3cc[nH]c3c2)cc(C(C)(C)C)c1 ; CC(C)(C)c1cc(-c2ccc3ccn(P(Cl)n4ccc5ccc(-c6cc(C(C)(C)C)cc(C(C)(C)C)c6)cc54)c3c2)cc(C(C)(C)C)c1]

In particular, triethylamine (34 mL, 245.5 mmol) in toluene (50 mL) was charged to a 110-mL glass jar and chilled inside the glove box refrigerator. PCl₃ (3.6 mL, 41.1 mmol) charged to a 1-L round-bottom flask along with 50 mL of toluene was placed in the glove box refrigerator at the same time. After an hour, both the solutions were taken out of the refrigerator and the triethylamine solution was slowly added to the PCl₃ solution. An additional 175 mL chilled toluene was added to the flask to keep the concentration at around 0.2 M (with respect to the PCl₃). The 6-(3,5-di-tert-butyl)-1H-indole (25.0 g, 81.8 mmol) was weighed into a 110-mL glass jar and slowly added portion-wise to the cold PCl₃/NEt₃ solution with vigorous stirring over a period of 0.5-1 h. A white precipitate started forming during the addition. The reaction mixture was allowed to warm to room temperature and was stirred for another 12 h. The reaction progress was monitored by ³¹P NMR. The next day, an aliquot of the reaction mixture was removed, filtered and analyzed by ³¹P NMR spectroscopy. The NMR shows formation of the desired mono-chlorophosphoramidite (δ 108.17 ppm) as the major product along with a minor amount of tri(indolyl)phosphine (δ 70.95 ppm). The crude reaction mixture was passed through a Celite™ pad. The filtrate was transferred to a 1-L flask and concentrated down to a 200-mL volume using the glove box vacuum pump (vacuum trap cooled with liquid nitrogen). The crude reaction mixture was sampled for ³¹P NMR and then used directly in the next step.

Next, ligand 2 was prepared from the bis(indolyl)chlorophosphine:

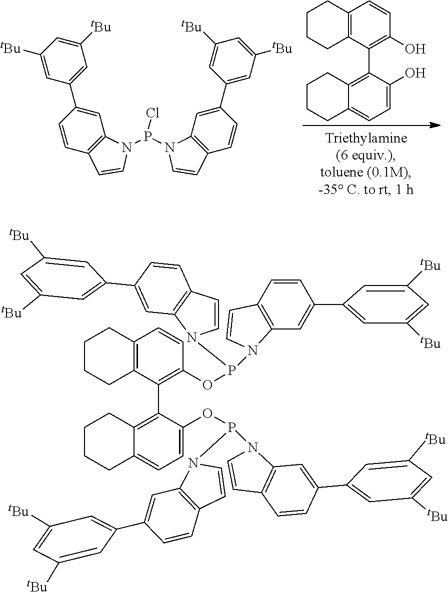

In particular, in a N₂-purged glove box, bis[6-(3,5-di-tert-butylphenyl)-1H-indolyl]chlorophosphine (27.75 g, 41.1 mmol) and toluene (200 mL) were charged to a 1-L round-bottom flask and stored in the glove box freezer for an hour (−35° C.). A solution of 5,5′,6,6′,7,7′,8,8′-octahydro-1,1′-bi-2-naphthol (5.5 g, 18.7 mmol) in 50 mL of toluene was added slowly. Triethylamine (15.5 mL, 112 mmol) was then added dropwise with stirring to the solution, resulting in immediate formation of a white precipitate; the reaction mixture later became cloudy and yellow. The mixture was allowed to stir at room temperature. After an hour, an aliquot of the reaction mixture was removed, filtered, and analyzed by ³¹P NMR which showed full conversion to the bis(phosphordiamidite) product (Ligand 2, δ 112.73 ppm) along with some cyclic phosphoramidite (<2%, δ 130.53 ppm) and tri(indolyl)phosphine (<6%, δ 70.96 ppm) byproducts. The reaction mixture was taken out from the glovebox and passed through a Celite™ pad to remove all the inorganic salts; the filtrate volatiles were removed on a rotary evaporator to leave an orange foamy solid. This crude material was divided into two batches (each batch approximately ˜10-12 g crude material) for silica gel chromatography. Two 330 g columns were used to purify the material using hexane-DCM as eluent. After purification of the two batches, the total isolated product was around 20 g of a white powder material for a 68% yield having 98% purity.

### Preparation Example 2: Ligand 3

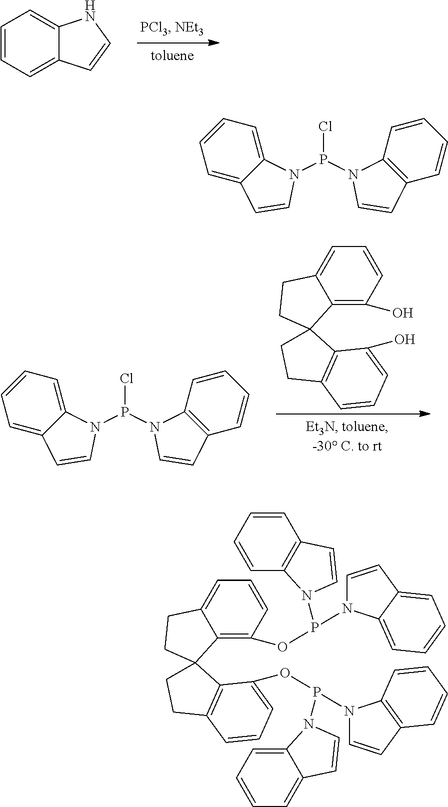

In a N₂-purged glove box, 2,2′,3,3′-Tetrahydro-1,1′-spirobi[indene]-7,7′-diol (0.58 g, 2.3 mmol) was added to a chilled solution of bis-indolylchlorophosphine (5.6 mmol) in toluene (10 ml) into a 110 mL glass jar. Triethylamine (1.3 mL, 9.2 mmol) was added dropwise with stirring to the solution, resulting in formation of a white precipitate. The reaction mixture was allowed to stir at room temperature and slowly warmed up to rt overnight. The next morning, an aliquot of the reaction mixture was removed, filtered, and analyzed by ³¹P NMR spectroscopy; the reaction was very clean and only one major peak (δ 100.12 ppm) was observed. The glass jar was taken out from the glovebox and the reaction mixture was passed over a Celite™ pad. The filtrate was concentrated down and loaded directly over to 330 g silica column using liquid injection. A 330 g gold silica gel column (5-25% dichloromethane in hexane) was utilized to purify the product, after column purification, 0.9 g of pure bisphosphoramidite product (Ligand 3) was obtained with 49% yield.

### Preparation Example 3: Ligand 4

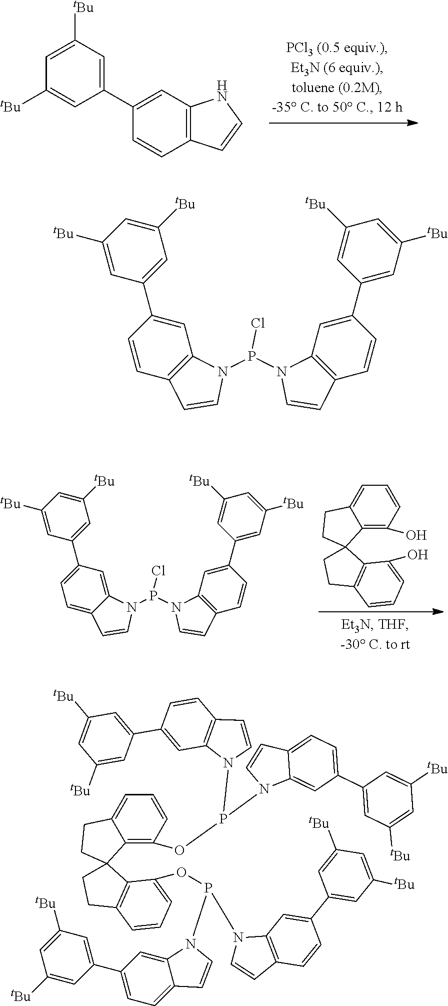

In a N₂-purged glove box, 2,2′,3,3′-Tetrahydro-1,1′-spirobi[indene]-7,7′-diol (0.275 g, 1.2 mmol) was added to a chilled solution of bis[6-(3,5-di-tert-butylphenyl)-1H-indolyl]chlorophosphine (2.8 mmol) in toluene (10 ml) into a 110 mL glass jar. Triethylamine (0.7 mL, 4.8 mmol) was added dropwise with stirring to the solution, resulting in immediate formation of a white precipitate. The reaction mixture was allowed to stir at room temperature and slowly warmed up to rt overnight. The next morning, an aliquot of the reaction mixture was removed, filtered, and analyzed by ³¹P NMR spectroscopy; the reaction was very clean and only one major peak (δ105.28 ppm) with some minor products were observed. The glass jar was taken out from the glove-box and the reaction mixture was passed over a Celite™ pad. The filtrate was concentrated down and loaded directly over to 330 g silica column using liquid injection. Silica gel column was required to remove all of the attendant by-products. A 330 g gold silica gel column (5-25% dichloromethane in hexane) was utilized to purify the bis product with the rest of the side products. After column purification, 0.95 g of pure bisphosphoramidite product (Ligand 4) was obtained with 51% yield.

### Preparation Example 4: Ligand 5

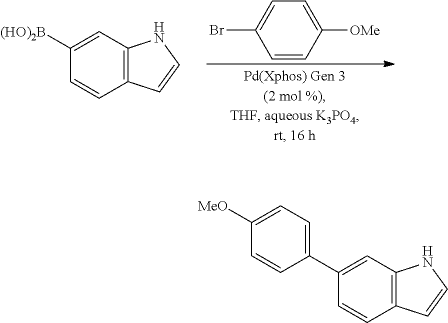 [SMILES: OB(O)c1ccc2cc[nH]c2c1 ; COc1ccc(Br)cc1 ; COc1ccc(-c2ccc3cc[nH]c3c2)cc1]

A 3-neck 250 mL round bottom flask was charged with 2 g (12.4 mmol) of 1H-indole-6-boronic acid, 0.2 g (0.25 mmol) of Precatalyst, and 80 mL of THF. The mixture was stirred for 5 minutes at room temperature. After 5 minutes, 2.5 g (13.7 mmol) of 4-bromoanisole was added to the solution, followed by approximately 50 mL of an aqueous solution of potassium phosphate tribasic (7.9 g, 38 mmol) in 25 mL of H₂O). The reaction mixture was then stirred at room temperature overnight. The next day, the reaction was monitored by LC-MS. Diethyl ether (80 mL) was added to the reaction mixture and the mixture was then transferred to a separatory funnel. The organic layer was separated, and the aqueous layer was further washed with 80 mL of diethyl ether (2×). The organic layers were combined and dried over MgSO₄ and activated carbon. The solvent was removed under reduced pressure to yield a brownish solid. The solid was purified by ISCO silica gel chromatography to yield 2.0 g (70%) of the product (6-(4-methoxyphenyl)-1H-indole).

Next, bis(indolyl)chlorophosphine was prepared from 6-(4-methoxyphenyl)-1H-indole:

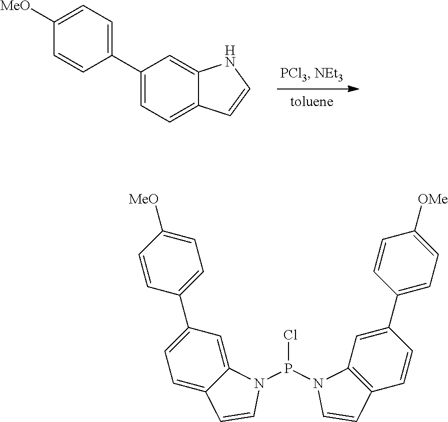 [SMILES: COc1ccc(-c2ccc3cc[nH]c3c2)cc1 ; COc1ccc(-c2ccc3ccn(P(Cl)n4ccc5ccc(-c6ccc(OC)cc6)cc54)c3c2)cc1]

In particular, in a N₂-purged glove box, phosphorus trichloride (0.3 mL, 3.2 mmol) and triethylamine (2.7 mL) were added to 20 mL of toluene in a 110-mL glass jar. The solution was placed in the glove box freezer (−35° C.) for 1 hour to chill. The 6-(4-methoxyphenyl)-1H-indole (1.45 g, 6.5 mmol) was weighed into a 50-mL glass jar and dissolved in 10 mL of toluene. The PCl₃/NEt₃ solution was removed from the freezer and the indole solution was added drop wise (by an additional funnel) with stirring to the cold PCl₃/NEt₃ solution. A copious amount of white precipitate formed during the addition. The reaction mixture was allowed to warm to room temperature and stirred overnight. The next day, an aliquot of the reaction mixture was removed, filtered and analyzed by ³¹P NMR spectroscopy. The NMR spectrum showed formation of the desired mono-chlorophosphoramidite (d 103.29 ppm) as the major product. The crude mixture was filtered through a Celite™ pad to remove the inorganic salts and the filtrate was further evaporated using glove box vacuum pump (keeping liquid nitrogen in the trap) leaving 3.1 g of the desired mono-chlorophosphoramidite as a yellowish powder (>90% yield). The compound was directly used on next step without further purification.

Next, Ligand 5 was prepared from bis(indolyl)chlorophosphine:

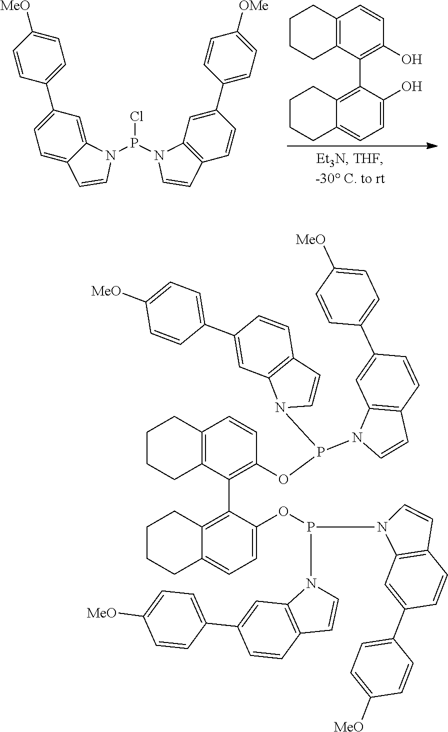

In particular, in a N₂-purged glove box, 5,5′,6,6′,7,7′,8,8′-octahydro-1,1′-bi-2-naphthol (0.4 g, 1.4 mmol) and bis[6-(4-methoxyphenyl)-1H-indolyl]chlorophosphine (1.5 g, 2.9 mmol) were weighed into a 110 mL glass jar and dissolved in 10 mL of THF to create a reddish yellow solution and kept in the freezer for an hour (−35° C.). Triethylamine (1.2 mL) was added dropwise with stirring to the solution, resulting in immediate formation of a white precipitate. The reaction mixture was allowed to stir at room temperature and slowly warmed up to 50° C. overnight. The next morning, an aliquot of the reaction mixture was removed, filtered, and analyzed by ³¹P NMR spectroscopy; full conversion to bisphosphoramidite product (δ 104.37 ppm) was observed. Two step purification was required to remove all of the attendant by-products. In the first step, a 330 g gold silica gel column (5-20% dichloromethane in hexane) was utilized to purify the bis product with the rest of the side products. In the second step, a 160 g neutral alumina column was utilized to further purify the bisphosphoramidite product from the indole side product (5-20% dichloromethane in hexane). After column purification, 0.6 g of pure bisphosphoramidite product (Ligand 5) was obtained with 35% yield.

### Preparation Example 5: Ligand 6

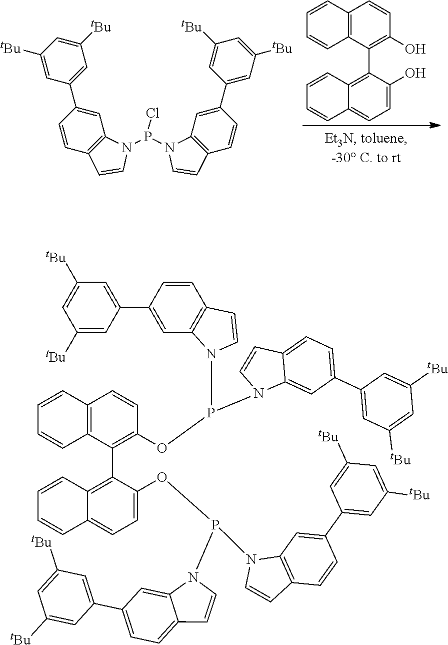

In a N₂-purged glove box, [1,1′-binaphthalene]-2,2′-diol (0.25 g, 0.9 mmol) was added to a chilled solution of bis[6-(3,5-di-tert-butylphenyl)-1H-indolyl]chlorophosphine (2.8 mmol) in toluene (5 ml) into a 110 mL glass jar. Triethylamine (0.5 mL, 3.6 mmol) was added dropwise with stirring to the solution, resulting in immediate formation of a white precipitate. The reaction mixture was allowed to stir at room temperature and slowly warmed up to rt overnight. The next morning, an aliquot of the reaction mixture was removed, filtered, and analyzed by ³¹P NMR spectroscopy. The glass jar was taken out from the glove-box and the reaction mixture was passed over a Celite™ pad. The filtrate was concentrated down and loaded directly over to 330 g silica column using liquid injection to purify the material. A 330 g gold silica gel column (5-25% dichloromethane in hexane) was utilized to purify the bis product with the rest of the side products. After column purification, 0.4 g of pure bisphosphoramidite product (Ligand 6) was obtained with 29% yield.

### Preparation Example 6: Ligand 7

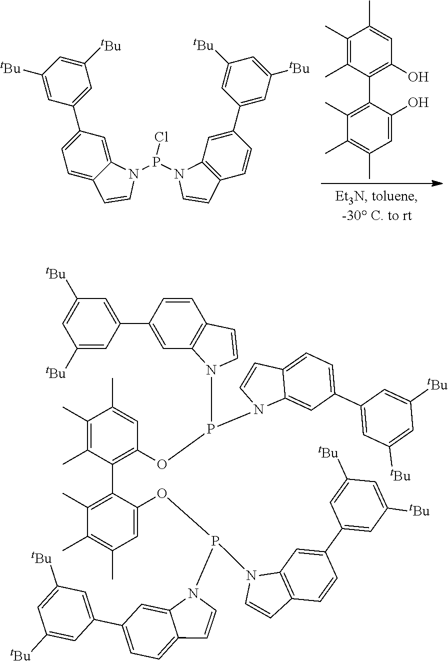

In a N₂-purged glove box, 4,4′,5,5′,6,6′-hexamethyl-[1,1′-biphenyl]-2,2′-diol (1.0 g, 3.7 mmol) and bis[6-(3,5-di-tert-butylphenyl)-1H-indolyl]chlorophosphine (6.2 g, 8.13 mmol) were weighed into a 220 mL glass jar and dissolved in 75 mL of THF to create a reddish yellow solution and kept in the freezer for an hour (−35° C.). Triethylamine (1.6 mL, 11.1 mmol) was added dropwise with stirring to the solution, resulting in immediate formation of a white precipitate. The reaction mixture was allowed to stir at room temperature and slowly warmed up to 50° C. overnight. The next morning, an aliquot of the reaction mixture was removed, filtered, and analyzed by ³¹P NMR. Two step purification was required to remove all of the attendant by-products. In particular, in a first step, a 330 g gold silica gel column (5-20% dichloromethane in hexane) was utilized to purify the bis product with the rest of the side products. In a second step, a 160 g neutral alumina column was utilized to further purify the bisphosphoramidite product (5-20% dichloromethane in hexane). After column purification, 1.2 g of pure bisphosphoramidite product (Ligand 7) was obtained with 28% yield.

### Preparation Example 7: Ligand 8

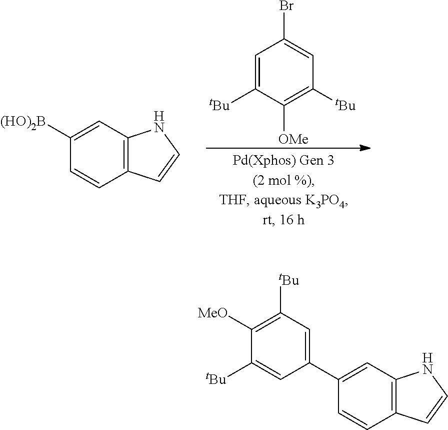 [SMILES: OB(O)c1ccc2cc[nH]c2c1 ; COc1c(C(C)(C)C)cc(Br)cc1C(C)(C)C ; COc1c(C(C)(C)C)cc(-c2ccc3cc[nH]c3c2)cc1C(C)(C)C]

A 3-neck 250 mL round bottom flask was charged with 3.0 g (18.6 mmol) of 6-indole boronic acid, 0.3 g (0.4 mmol) of Precatalyst, and 60 mL of THF. The mixture was stirred for 5 minutes at room temperature. After 5 minutes, 6.2 g (20.5 mmol) of 4-bromo-3,5-di-tert-butylanisole was added to the solution, followed by approximately 75 mL of an aqueous solution of potassium phosphate tribasic (12 g, 55 mmol) in 75 mL of H₂O). The reaction mixture was then stirred at room temperature overnight. The next day, the reaction was monitored by LC-MS. Diethyl ether (80 mL) was added to the reaction mixture and the mixture was then transferred to a separatory funnel. The organic layer was separated, and the aqueous layer was further washed with 80 mL of diethyl ether (2×). The organic layers were combined and dried over MgSO₄. The solvent was removed under reduced pressure to yield a brownish solid. The solid was purified by ISCO silica gel chromatography to yield 5.2 g (84% yield) of the product (6-(3,5-di-tert-butyl-4-methoxyphenyl)-1H-indole).

Next, bis(indolyl)chlorophosphine was prepared with the (6-(3,5-di-tert-butyl-4-methoxyphenyl)-1H-indole):

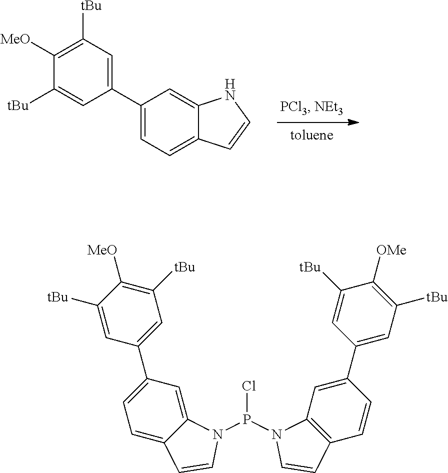 [SMILES: COc1c(C(C)(C)C)cc(-c2ccc3cc[nH]c3c2)cc1C(C)(C)C ; COc1c(C(C)(C)C)cc(-c2ccc3ccn(P(Cl)n4ccc5ccc(-c6cc(C(C)(C)C)c(OC)c(C(C)(C)C)c6)cc54)c3c2)cc1C(C)(C)C]

In particular, in a N₂-purged glove box, phosphorus trichloride (0.6 mL, 6.7 mmol) was added to 20 mL of toluene in a 110-mL glass jar. The solution was placed in the glove box freezer (−35° C.) for 1 hour to chill. After an hour, triethylamine (5.6 mL) was added to the PCl₃ solution and kept it back in the freezer. 6-(3,5-di-tert-butyl-4-methoxyphenyl)-1H-indole (4.5 g, 13.5 mmol) was weighed into a 50-mL glass jar and dissolved in 20 mL of toluene. The PCl₃/NEt₃ solution was removed from the freezer and the indole solution was added drop wise with stirring to the cold PCl₃/NEt₃ solution. A white precipitate formed during the addition. The reaction mixture was allowed to warm to room temperature and stirred for another 12 h at rt. The next day, an aliquot of the reaction mixture was removed, filtered and analyzed by ³¹P NMR spectroscopy. The NMR spectrum showed formation of the desired mono-chlorophosphoramidite (δ 108.56 ppm) as the major product. The crude NMR was clean enough to move forward for the next step without further purification.

Next, Ligand 8 was prepared with the bis(indolyl)chlorophosphine:

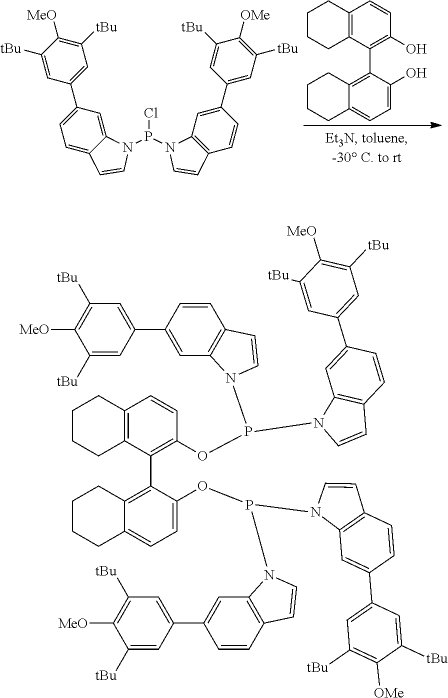

In a N₂-purged glove box, 5,5′,6,6′,7,7′,8,8′-octahydro-1,1′-bi-2-naphthol (0.8 g, 2.7 mmol) was added to chilled a solution of bis[4-(3,5-di-tert-butyl-4-methoxyphenyl)-1H-indolyl]chlorophosphine (6.7 mmol) in toluene (20 mL) into a 110 mL glass jar. Triethylamine (1.5 mL, 11 mmol) was added dropwise with stirring to the solution, resulting in immediate formation of a white precipitate. The reaction mixture was allowed to stir at room temperature and slowly warmed up to rt overnight. The next morning, an aliquot of the reaction mixture was removed, filtered, and analyzed by ³¹P NMR spectroscopy; full conversion to bisphosphoramidite with some minor products were observed. The glass jar was taken out from the glove-box and the reaction mixture was passed over a Celite™ pad. The filtrate was concentrated down and loaded directly over to 330 g silica column using liquid injection. A 330 g gold silica gel column (5-60% dichloromethane in hexane) was utilized to purify the product. After column purification, 1.8 g of pure bisphosphoramidite product (Ligand 8) was obtained with 40% yield.

### Examples 1-15

In the following Examples 1-15, reaction conversion, selectivity, and regioselectivity (N/I ratio) were measured by ¹H NMR in C₆D₆, product structures and composition were additionally supported by ¹³C NMR in C₆D₆.

The reaction mixtures were analyzed by ¹H and ¹³C NMR. Neat substrate hydroformylation involved either catalyst activation during the initial reaction period or catalyst pre-activation in toluene prior to hydroformylation, followed by the transfer of the activated catalyst to the particular substrate utilized. In addition to linear aldehydes as the major products, hydroformylation generated several by-products, which were detected and analyzed by NMR:

A. Branched aldehydes that determine the reaction regioselectivity (N/I or N/B is a molar ratio of the normal to branched aldehyde):

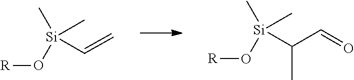

B. The Brook rearrangement byproduct that forms from the branched aldehyde at elevated temperature:

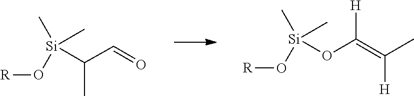

C. The olefin hydrogenation byproduct that unproductively consumes the olefin:

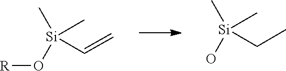

### Example 1

Catalyst Precursor (25.8 mg; 0.1 mmol) and Ligand 1 (164.6 mg; 0.2 mmol) were dissolved in nitrogen purged toluene (100 g) with stirring in the purge box. Neat Substrate 1 (25 g; 1.67 mmol) was purged with nitrogen and quickly introduced into a 150 mL open reactor under nitrogen blanket. The reactor was sealed and purged 3 times with syngas with subsequent stirring at low rate after each charge and stopping stirring before venting to give an Rh/Ligand 1 stock solution. Then the Rh/Ligand 1 stock solution in toluene (0.5 g; 0.58 mL) was charged to the reactor by syringe. The initial syngas pressure of 40-60 psi was charged and the temperature was gradually raised to 70° C. with slow stirring. Then the syngas pressure was adjusted to ˜100 psig and stirring to ˜400 rpm. The reaction was carried out at 70° C. and ˜100 psig of syngas. In 2 h the conversion of Substrate 1 reached 100% with N/B=74. Reaction parameters, conversion, and the N/I ratio as measured via NMR are described below in Table 2.

### Example 2

Example 2 follows the same process as Example 1 except for that a different concentration of the Catalyst Precursor was utilized, as described below in Table 2, which influenced the time required to achieve 100% conversion of Substrate 1.

### Example 3

Example 3 follows the same process as Example 1, using an Rh/Ligand 1 stock solution that had been diluted with toluene 8 times, but Example 3 was carried out at 90° C. instead of 70° C., which influenced the time required to achieve 100% conversion of Substrate 1. After 8 hours, conversion of the Substrate 1 was 87% with an N/I ratio of 78, as measured via NMR and as described in Table 2. The content of the olefin hydrogenation byproduct in Example 3 was 4.5% and the content of the Brook rearrangement byproduct was 2.1%.

### Example 4

Catalyst Precursor (25.8 mg; 0.1 mmol) was dissolved in nitrogen purged toluene (100 g). Ligand 1 (20.6 mg; 0.025 mmol) was dissolved in 12.5 g (14.4 mL) of this solution with stirring under nitrogen. This mixture was diluted 8 times by adding 87.5 g (100.9 mL) of toluene. About 30-50 mL of this solution was transferred to a 150 mL Parr reactor #1 and kept under 100 psig of syngas at 70° C. for 30 min. The reactor was then cooled to 30-40° C. Neat Substrate 1 (25 g; 1.67 mmol) was purged with nitrogen and quickly introduced into a 150 mL open Parr reactor #2 under a nitrogen blanket. The reactor was sealed and purged 3 times with syngas with subsequent stirring at low rate after each charge and stopping stirring before venting. Then a portion of the activated Rh/Ligand 1 stock solution in toluene (0.5 g; 0.58 mL) from reactor #1 was charged to reactor #2 by syringe. The initial syngas pressure of 40-60 psi was introduced and the temperature was gradually raised to 70° C. with slow stirring. Then the syngas pressure was adjusted to ˜100 psig and stirring to ˜400 rpm. The reaction was carried out at 70° C. and ˜ 100 psig of syngas. In 4 h the conversion of Substrate 1 reached 93% with N/B=82 (as set forth below in Table 2). The amount of the olefin hydrogenation byproduct was only 2.9% and no Brook rearrangement byproduct was detected via NMR.

### Examples 5-16

Examples 5-16 follow the same process as Example 1 except for that a different concentration of the Catalyst Precursor was utilized, as described below in Table 2, and different ligand were utilized, as also described in Table 2 along with the reaction parameters and results (as measured via NMR) of Examples 5-16.

### Example 17

Catalyst Precursor (25.8 mg; 0.1 mmol) and Ligand 1, (164.6 mg; 0.2 mmol) were dissolved in nitrogen purged toluene (100 g) with stirring in the purge box. Neat Substrate 4 (25 g; 2.31 mmol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (0.5 g; 0.58 mL) was charged to the reactor by syringe. The initial syngas pressure of 40-60 psi was introduced and the temperature was gradually raised to 70° C. with slow stirring. Then the syngas pressure was adjusted to ˜100 psig and stirring to ˜400 rpm. The reaction was carried out at 70° C. and ˜100 psig of syngas. In 2 h the conversion of Substrate 4 reached >99% with N/B=57 as measured via NMR and described below in Table 2.

### Example 18

Catalyst Precursor (25.8 mg; 0.1 mmol) and Ligand 1 (164.6 mg; 0.2 mmol) were dissolved in nitrogen purged toluene (100 g) with stirring in the purge box. Neat Substrate 2 (25 g; 35.5 mmol) was purged with nitrogen and quickly introduced into a 80 mL open reactor under nitrogen blanket. The reactor was sealed and purged 3 times with syngas with subsequent stirring at low rate after each charge and stopping stirring before venting. Then the Rh/Ligand 1 stock solution in toluene (2.5 g; 2.9 mL) prepared above was charged to the reactor by syringe. The initial syngas pressure of 40-60 psi was charged and the temperature was gradually raised to 70° C. with slow stirring. Then the syngas pressure was adjusted to ˜100 psig and stirring to ˜400 rpm. The reaction was carried out at 70° C. and ˜100 psig of syngas. In 2 h the conversion of Substrate 2 reached 100% with N/B=98 as measured via NMR and described below in Table 2.

### Example 19

Catalyst Precursor (25.8 mg; 0.1 mmol) and Ligand 1 (164.6 mg; 0.2 mmol) were dissolved in nitrogen purged toluene (100 g) with stirring in the purge box. Substrate 3 (10 g) was mixed with hexane (15 g; 22.8 mL), purged by nitrogen and introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (0.5 g; 0.58 mL) prepared above was charged to the reactor by syringe. The initial syngas pressure of 40-60 psi was introduced and the temperature was gradually raised to 70° C. with slow stirring. Then the syngas pressure was adjusted to ˜100 psig and stirring to ˜400 rpm. The reaction was carried out at 70° C. and ˜100 psig of syngas. In 2 h the conversion of Substrate 3 reached 63% as measured via NMR and described below in Table 2.

### Examples 20 and 21

Examples 20 and 21 follow the process of Example 19, except Examples 20 and 21 use a different concentration of Rh (but the same Rh/Ligand ratio). The reaction parameters and results (as measured via NMR) of Examples 20 and 21 are set forth below in Table 2.

### Example 22

Catalyst Precursor (25.8 mg; 0.1 mmol) and Ligand 1 (164.6 mg; 0.2 mmol) were dissolved in nitrogen purged toluene (100 g) with stirring in the purge box. Neat Substrate 5 (25 g; 32.6 mmol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (5 g; 5.8 mL) was charged to the reactor by syringe. The initial syngas pressure of 40-60 psi was introduced and the temperature was gradually raised to 70° C. with slow stirring. Then the syngas pressure was adjusted to ˜100 psig and stirring to ˜400 rpm. The reaction was carried out at 70° C. and ˜100 psig of syngas. In 2 h the conversion of Substrate 5 reached 98% with N/B=63 as measured via NMR and described below in Table 2.

### Example 23

Catalyst Precursor (25.8 mg; 0.1 mmol) and Ligand 1 (164.6 mg; 0.2 mmol) were dissolved in nitrogen purged toluene (100 g) with stirring in the purge box. Neat Substrate 7 (25 g; 0.10 mol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (2.5 g; 2.9 mL) was charged to reactor by syringe. The initial syngas pressure of 40-60 psi was charged and the temperature was gradually raised to 70° C. with slow stirring. Then the syngas pressure was adjusted to ˜100 psig and stirring to ˜400 rpm. The reaction was carried out at 70° C. and ˜ 100 psig of syngas. In 2 h the conversion of Substrate 7 reached 100% with N/B=41 as measured via NMR and described below in Table 2.

### Example 24

Catalyst Precursor (25.8 mg; 0.1 mmol) and Ligand 1 (164.6 mg; 0.2 mmol) were dissolved in nitrogen purged toluene (100 g) with stirring in the purge box. Neat Substrate 6 (25 g; 0.134 mol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (2.5 g; 2.9 mL) was charged to the reactor by syringe. The initial syngas pressure of 40-60 psi was charged and the temperature was gradually raised to 70° C. with slow stirring. Then the syngas pressure was adjusted to ˜100 psig and stirring to ˜400 rpm. The reaction was carried out at 70° C. and ˜100 psig of syngas. In 2 h the conversion of Substrate 6 reached 100% with N/B=46 as measured via NMR and described below in Table 2.

### Example 25

Catalyst Precursor (25.8 mg; 0.1 mmol) and Ligand 10 (97.9 mg; 0.1 mmol) were dissolved in nitrogen purged toluene (100 g) with stirring in the purge box. Neat Substrate 6 (25 g; 0.134 mol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Ligand 10 stock solution in toluene (2.5 g; 2.9 mL) was charged to the reactor by syringe. The initial syngas pressure of 40-60 psi was charged and the temperature was gradually raised to 70° C. with slow stirring. Then the syngas pressure was adjusted to ˜100 psig and stirring to ˜400 rpm. The reaction was carried out at 70° C. and ˜100 psig of syngas. In 6 h the conversion of Substrate 6 reached 100% with N/B=95 as measured via NMR and described below in Table 2.

### Example 26

Catalyst Precursor (25.8 mg; 0.1 mmol) and Ligand 1 (164.6 mg; 0.2 mmol) were dissolved in nitrogen purged toluene (100 g) with stirring in the purge box. Substrate 8 (8.5 g; 0.085 mol) was mixed with toluene (8.5 g; 9.8 mL), purged with nitrogen, and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (0.85 g; 0.98 mL) was charged to reactor by syringe. The initial syngas pressure of 40-60 psi was charged and the temperature was gradually raised to 70° C. with slow stirring. Then the syngas pressure was adjusted to ˜100 psig and stirring to ˜400 rpm. The reaction was carried out at 70° C. and ˜100 psig of syngas. In 4 h the conversion of Substrate 8 reached 99% with N/B=147 as measured via NMR and described below in Table 2.

### Example 27

Catalyst Precursor (25.8 mg; 0.1 mmol) and Ligand 1 (164.6 mg; 0.2 mmol) were dissolved in nitrogen purged toluene (100 g) with stirring in the purge box. Substrate 9 (11.25 g) was mixed with toluene (11.25 g, 13 mL), purged with nitrogen, and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (2.5 g; 2.9 mL) was charged to reactor by syringe. The initial syngas pressure of 40-60 psi was charged and the temperature was gradually raised to 90° C. with slow stirring. Then the syngas pressure was adjusted to ˜ 100 psig and stirring to ˜400 rpm. The reaction was carried out at 90° C. and ˜100 psig of syngas. In 2 h the conversion of the Substrate 9 was only 1%. The reaction mixture was cooled down to RT and an additional amount of the Rh/Ligand 1 stock solution in toluene (2.5 g; 2.9 mL) was introduced to the reactor by syringe. The reaction continued at 90° C. and ˜100 psig of syngas, and in 4 h the conversion of Substrate 9 was 100% as measured via NMR and described below in Table 2.

### Example 28

Catalyst Precursor (25.8 mg; 0.1 mmol) and Ligand 1 (164.6 mg; 0.2 mmol) were dissolved in nitrogen purged toluene (100 g) with stirring in the purge box. Substrate 10 (25 g) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Ligand 1 stock solution in toluene (2.5 g; 2.9 mL) was charged to reactor by syringe. The initial syngas pressure of 40-60 psi was charged and the temperature was gradually raised to 90° C. with slow stirring. Then the syngas pressure was adjusted to ˜100 psig and stirring to ˜400 rpm. The reaction was carried out at 90° C. and ˜100 psig of syngas. In 2 h the conversion of Substrate 10 reached 100% as measured via NMR and described below in Table 2.

### Comparative Example 1

Catalyst Precursor (25.8 mg; 0.1 mmol) and Comparative Ligand 1 (524.6 mg; 2 mmol) were dissolved in nitrogen purged toluene (200 g; 230.7 mL) with stirring in the purge box. Neat Substrate 1 (25 g; 1.67 mmol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Comparative Ligand 1 catalyst stock solution in toluene (2.5 g; 2.88 mL) was charged by syringe to this reactor. The temperature was gradually raised to 90° C. with slow stirring under initial syngas pressure of ˜50 psi. Then the syngas pressure was adjusted to ˜100 psig and stirring to ˜400 rpm. The reaction was carried out at 90° C. and 100 psig of syngas. In 1 h the conversion of Substrate 1 reached 96% and in 2 h conversion was 100% with N/B=2.6 as measured via NMR and described below in Table 2.

### Comparative Example: 2

Catalyst Precursor (25.8 mg; 0.1 mmol) and Comparative Ligand 2 (405 mg, 2 mmol) were dissolved in nitrogen purged toluene (100 g; 115.3 mL) with stirring in the purge box. Neat Substrate 1 (25 g; 1.67 mmol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Comparative Ligand 2 catalyst stock solution in toluene (2.5 g; 2.88 mL) was charged by syringe to this reactor. The temperature was gradually raised to 90° C. with slow stirring under initial syngas pressure of ˜50 psi. Then the syngas pressure was adjusted to ˜100 psig and stirring to ˜400 rpm. The reaction was carried out at 90° C. and 100 psig of syngas. In 2 h the conversion of Substrate 1 reached 100% with N/B=2.3 as measured via NMR and described below in Table 2.

### Comparative Examples 3-4

Comparative Examples 3-4 follow the process of Comparative Example 2, except Comparative Examples 3-4 use a different concentration of Rh (but the same Rh/Ligand ratio). The reaction parameters and results (as measured via NMR) of Comparative Examples 3-4 are set forth below in Table 2.

### Comparative Example 5

Catalyst Precursor (25.8 mg; 0.1 mmol) and Comparative Ligand 3 (167.8 mg; 0.2 mmol) were dissolved in nitrogen purged toluene (100 g) with stirring in the purge box. Neat Substrate 1 (25 g; 1.67 mmol) was purged with nitrogen and quickly introduced into a 150 mL open reactor under nitrogen blanket. The reactor was sealed and purged 3 times with syngas with subsequent stirring at low rate after each charge and stopping stirring before venting. Then the Rh/Comparative Ligand 2 stock solution in toluene (1.25 g; 1.44 mL) was charged to the reactor by syringe. The temperature was gradually raised to 70° C. with slow stirring under initial syngas pressure of 40-60 psi. Then the syngas pressure was adjusted to ˜100 psig and stirring to ˜400 rpm. The reaction was carried out at 70° C. and ˜100 psig of syngas. In 2 h the conversion reached 100% with N/B=17 as measured via NMR and described below in Table 2.

### Comparative Examples 6-8

Comparative Examples 6-8 follow the process of Comparative Example 5, except Comparative Examples 6-9 use a different concentration of Rh (but the same Rh/Ligand ratio). The reaction parameters and results (as measured via NMR) of Comparative Examples 6-9 are set forth below in Table 2.

In Table 2 below, C.E. indicates Comparative Example, C.L. indicates Comparative Ligand, L/Rh indicates the molar ratio of the particular Ligand utilized to Rh content in the Catalyst Precursor, and N/B is the ratio of the target linear aldehyde product versus the branched aldehyde byproduct.

TABLE 2

| | | | Rh | Ligand | | Temp | Time | Conversion | |
|---|---|---|---|---|---|---|---|---|---|
| Ex. | Substrate | Solvent | ppm | (L) | L/Rh | (° C.) | (h) | (%) | N/B |
| 1 | 1 | Neat | 2 | 1 | 2:1 | 70 | 2 | 100 | 74 |
| 2 | 1 | Neat | 1 | 1 | 2:1 | 70 | 2 | 94 | 81 |
| | | | | | | | 3.5 | 100 | 80 |
| 3 | 1 | Neat | 0.25 | 1 | 2:1 | 90 | 2 | 65 | 52 |
| | | | | | | | 4 | 84 | 58 |
| | | | | | | | 48 | 87 | 78 |
| 4¹ | 1 | Neat | 0.25 | 1 | 2:1 | 70 | 25 | 71 | 80 |
| | | | | | | | 46 | 93 | 84 |
| | | | | | | | 18 | 100 | 95 |
| 5 | 1 | Neat | 2 | 2 | 2:1 | 70 | 2 | 100 | 43 |
| 6 | 1 | Neat | 1 | 2 | 2:1 | 70 | 2 | 97 | 46 |
| | | | | | | | 3 | 100 | 46 |
| 7 | 1 | Neat | 2 | 10 | 2:1 | 70 | 2 | 61 | 304 |
| | | | | | | | 4 | 85 | 302 |
| | | | | | | | 8 | 98 | 333 |
| 8 | 1 | Neat | 2 | 10 | 1:1 | 70 | 2 | 70 | 294 |
| | | | | | | | 4 | 92 | 306 |
| | | | | | | | 6 | 98 | 301 |
| 9 | 1 | Neat | 2 | 9 | 1:1 | 70 | 2 | 83 | 208 |
| | | | | | | 70 | 4 | 100 | 200 |
| 10 | 1 | Neat | 2 | 4 | 2:1 | 70 | 2 | 75 | 30 |
| | | | | | | 70 | 4 | 97 | 29 |
| | | | | | | 70 | 19 | 100 | 32 |
| 11 | 1 | Neat | 2 | 3 | 2:1 | 70 | 2 | 66 | 38 |
| | | | | | | 70 | 4 | 91 | 39 |
| | | | | | | 70 | 20 | 100 | 42 |
| 12 | 1 | Neat | 2 | 5 | 2:1 | 70 | 2 | 95 | 74 |
| | | | | | | 70 | 4 | 100 | 73 |
| 13 | 1 | Neat | 2 | 6 | 2:1 | 70 | 2 | 91 | 63 |
| | | | | | | 70 | 4 | 100 | 63 |
| 14 | 1 | Neat | 2 | 7 | 2:1 | 70 | 2 | 96 | 64 |
| | | | | | | 70 | 3.5 | 100 | 64 |
| 15 | 1 | Neat | 2 | 8 | 2:1 | 70 | 2 | 100 | 48 |
| 16 | 1 | Neat | 1 | 8 | 2:1 | 70 | 2 | 96 | 49 |
| | | | | | | 70 | 4 | 100 | 50 |
| 17 | 4 | Neat | 2 | 1 | 2:1 | 70 | 2 | 95 | 57 |
| | | | | | | 70 | 3 | >99 | 57 |
| 18 | 2 | Neat | 10 | 1 | 2:1 | 70 | 2 | 100 | 98 |
| 19 | 3 | 2² | 2 | 1 | 2:1 | 70 | 2 | 63 | — |
| 20 | 3 | 2² | 5 | 1 | 2:1 | 70 | 2 | 81 | — |
| 21 | 3 | 2² | 10 | 1 | 2:1 | 70 | 2 | 99 | — |
| 22 | 5 | Neat | 10 | 1 | 2:1 | 90 | 2 | 28 | 44 |
| | | | | | | | 20 | 98 | 63 |
| 23 | 7 | Neat | 20 | 1 | 2:1 | 70 | 2 | 100 | 41 |
| 24 | 6 | Neat | 10 | 1 | 2:1 | 70 | 2 | 100 | 46 |
| 25 | 6 | Neat | 10 | 10 | 1:1 | 70 | 4 | 87 | 97 |
| | | | | | | | 6 | 100 | 95 |
| 26 | 8 | 1³ | 10 | 1 | 2:1 | 70 | 4 | 99 | 147 |
| 27 | 9 | 1³ | 20 | 1 | 2:1 | 90 | 4 | 100 | — |
| 28 | 10 | 1⁴ | 10 | 1 | 2:1 | 90 | 2 | 100 | — |
| C.E. | 1 | Neat | 5 | C.L. 1 | 20:1 | 90 | 2 | 100 | 2.6 |
| 1 | | | | | | | | | |
| C.E. | 1 | Neat | 10 | C.L. 2 | 20:1 | 90 | 2 | 100 | 2.3 |
| 2 | | | | | | | | | |
| C.E. | 1 | Neat | 5 | C.L. 2 | 20:1 | 90 | 2 | 45 | 2.3 |
| 3 | | | | | | | | | |
| C.E. | 1 | Neat | 5 | C.L. 2 | 20:1 | 90 | 2 | 10 | 2.3 |
| 4 | | | | | | | | | |
| C.E. | 1 | Neat | 5 | C.L. 3 | 2:1 | 70 | 2 | 100 | 17 |
| 5 | | | | | | | | | |
| C.E. | 1 | Neat | 5 | C.L. 3 | 2:1 | 50 | 2 | 73 | 28 |
| 6 | | | | | | | 4 | 95 | 29 |
| C.E. | 1 | Neat | 2 | C.L. 3 | 2:1 | 70 | 2 | 98 | 17 |
| 7 | | | | | | | 3.5 | 100 | 19 |
| C.E. | 1 | Neat | 1 | C.L. 3 | 2:1 | 70 | 2 | 95 | 19 |
| 8 | | | | | | | 4 | 100 | 20 |

¹The Rh/L catalyst was pre-activated;
²40% solution;
³50% solution;
⁴58% soluution.

### Example 29

Catalyst Precursor (25.8 mg; 0.1 mmol) was dissolved in nitrogen purged toluene (100 g) to give a solution. Ligand 1 (20.6 mg; 0.025 mmol) was dissolved in 12.5 g (14.4 mL) of this solution with stirring under nitrogen. This mixture was diluted 8 times by adding 87.5 g (100.9 mL) of toluene. About 30-50 mL of this solution was transferred to a 150 mL Parr reactor #1 and kept under 100 psig of syngas at 70° C. for 30 min. Neat Substrate 1 (25 g; 1.67 mmol) was purged with nitrogen and quickly introduced into a 150 mL open Parr reactor #2 under a nitrogen blanket. The reactor was sealed and purged 3 times with syngas with subsequent stirring at low rate after each charge and stopping stirring before venting. Then a portion of the activated Rh/Ligand 1 stock solution in toluene (0.5 g; 0.58 mL) from reactor #1 was charged to reactor #2 by syringe. The initial syngas pressure of 40-60 psi was introduced and the temperature was gradually raised to 70° C. with slow stirring. Then the syngas pressure was adjusted to ˜100 psig and stirring to ˜400 rpm. The reaction was carried out at 70° C. and ˜ 100 psig of syngas. Results are set forth below in Table 3.

### Examples 30-33

Examples 30-33 follow the same process as Example 29 except for that a different Ligand was utilized, as described below in Table 3, along with different concentrations of Rh utilized, different temperatures, and different reaction times, which are also set forth below in Table 3.

| | | | Rh | Ligand | | Temp | Time | Conversion | |
|---|---|---|---|---|---|---|---|---|---|
| Ex. | Substrate | Solvent | ppm | (L) | L/Rh | (° C.) | (h) | (%) | N/B |
| 29 | 1 | Neat | 0.25 | 1 | 2:1 | 90 | 8 | 87 | 78 |
| 30 | 1 | Neat | 1 | 2 | 2:1 | 70 | 3 | 100 | 46 |
| 31 | 1 | Neat | 2 | 5 | 2:1 | 70 | 4 | 100 | 73 |
| 32 | 1 | Neat | 2 | 7 | 2:1 | 70 | 3.5 | 100 | 64 |
| 33 | 1 | Neat | 2 | 4 | 2:1 | 70 | 4 | 97 | 29 |

All amounts, ratios, and percentages herein are by weight, unless otherwise indicated. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The abbreviations used herein have the definitions in Table 4.

TABLE 4
Abbreviations

| Abbreviation | Definitions |
|---|---|
| acac | acetyl acetonate |
| ° C. | degrees Celsius |
| FTIR | Fourier transform infra-red |
| g | gram |
| GPC | gel permeation chromatography |
| h | hour |
| kPa | kiloPascals |
| Me | methyl |
| mg | milligram |
| min | minute |
| mL | milliliter |
| mm | millimeter |
| Mmol | millimole |
| Mn | number average molecular weight |
| | measured by GPC |
| Mw | weight average molecular weight |
| | measured by GPC |
| mPa · s | milliPascal seconds |
| NMR | nuclear magnetic resonance |
| PDI | Polydispersity index |
| | (calculated as Mw/Mn) |
| Ph | phenyl |
| psi | pounds per square inch |
| RPM | revolutions per minute |
| RT | room temperature of 25 ± 5° C. |
| THF | tetrahydrofuran |
| μm | micrometer |
| Vi | vinyl |
| ppm | parts per million by weight |

### Problems to be Addressed

The lack of a good catalyst system constitutes a significant challenge for the commercialization of a hydroformylation process for organosilicon compounds. Previously proposed processes suffer from one or more of the following drawbacks: slow reaction rate, low linear selectivity, and high catalyst loading. Slow reaction rate leads to low productivity. The high catalyst loading used would lead to difficulties in catalyst recycling. Low linear selectivity would eventually lead to product decomposition since the branched product tends to undergo Brook rearrangement reaction.

The present hydroformylation process provides one or more benefits over previously proposed processes; i.e., faster reaction rate, improved selectivity, and lower catalyst loadings to achieve these. As shown in the examples above, the hydroformylation process can produce a reaction product, which comprises: a) a first organosilicon compound comprising a linear aldehyde-functional moiety, and b) a second organosilicon compound comprising a branched aldehyde-functional moiety; wherein a molar ratio of the linear aldehyde-functional moiety/the branched aldehyde-functional moiety (N/I ratio)>25, alternatively >30.

1. A process for preparing an aldehyde-functional organosilicon compound, said process comprising:
1) combining, under conditions to catalyze hydroformylation reaction, starting materials comprising:
(A) a gas comprising hydrogen and carbon monoxide,
(B) a vinyl-functional organosilicon compound having at least one vinyl group covalently bonded to silicon, and
(C) a rhodium/ligand complex catalyst, where the ligand has formula (C1), (C2), and/or (C3): 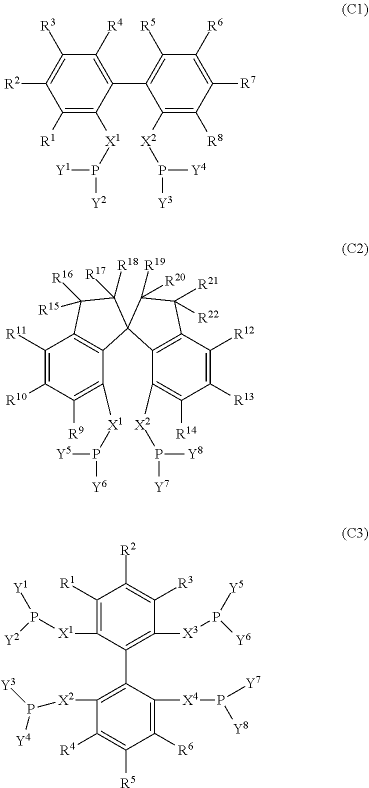
where:
R¹-R²² are each independently selected from hydrogen, a hydrocarbyl group, a heteroaryl group, a halogen atom, or a heterocarbyl group, wherein two or more of R¹-R²² may optionally be bonded together to give one or more cyclic moieties;
each of X¹-X⁴ is independently selected from O, CH₂, NH, NR, NSO₂R or NSO₂A, where each R is an independently selected substituted or unsubstituted alkyl or aryl group and each A is an independently selected aryl or heteroaryl group; and
each of Y¹-Y⁸ is an independently selected nitrogen-containing heterocyclic moiety bonded to P via N, wherein each heterocyclic moiety may be substituted with one or more groups or atoms selected from alkyl, aryl, heteroaryl, alkoxy, acyl, carboxyl, carboxylate, cyano, —SO₃H, sulfonate, amino, trifluoromethyl, and halogen.

2. The process of claim 1, where starting material (B) comprises a vinyl-functional silane of formula (B1): R^{A}ₓSiR²³₍₄₋ₓ₎, where each R^{A} is a vinyl group; each R²³ is independently selected from the group consisting of an alkyl group of 1 to 18 carbon atoms, an aryl group of 6 to 18 carbon atoms, an acyloxy group of 2 to 18 carbon atoms, and an hydrocarbonoxy-functional group of 1 to 18 carbon atoms; and subscript x is 1 to 4.

3. The process of claim 1, where the vinyl-functional organosilicon compound comprises a vinyl-functional polyorganosiloxane of unit formula (B2-1):
(R²³₃SiO_{1/2})ₐ(R²³₂R^{A}SiO_{1/2})_{b}(R²³₂SiO_{2/2})_{c}(R²³R^{A}SiO_{2/2})_{d}(R²³SiO_{3/2})ₑ(R^{A}SiO_{3/2})(SiO_{4/2})_{g}(ZO_{1/2})ₕ;
where each R^{A} is a vinyl group, and each R²³ is independently selected from the group consisting of an alkyl group of 1 to 18 carbon atoms, an aryl group of 6 to 18 carbon atoms, an acyloxy group of 2 to 18 carbon atoms, and an hydrocarbonoxy group of 1 to 18 carbon atoms; each Z is independently selected from the group consisting of a hydrogen atom and R²⁴, where each R²⁴ is independently selected from the group consisting of alkyl groups of 1 to 18 carbon atoms and aryl groups of 6 to 18 carbon atoms; subscripts a, b, c, d, e, f, and g represent numbers of each unit in formula (B2-1) and have values such that subscript a>0, subscript b≥0, subscript c≥0, subscript d≥0, subscript e≥0, subscript f≥0, subscript g≥0; and subscript h has a value such that 0≤h/(e+f+g)≤1.5, 10,000≥(a+b+c+d+e+f+g)≥2, and a quantity (b+d+f)≥1.

4. The process of claim 3, where the vinyl-functional polyorganosiloxane is cyclic and has a unit formula selected from the group consisting of:
(R²³R^{A}SiO_{2/2})_{d}, where each of R²³ and R^{A} is as defined above, and subscript d is 3 to 12;
(R²³₂SiO_{2/2})_{c′}(R²³R^{A}SiO_{2/2})_{d}, where each of R²³ and R^{A} is as defined above, c′ is >0 to 6, and d is 3 to 12; and
a combination thereof.

5. The process of claim 3, where the vinyl-functional polyorganosiloxane is linear and comprises unit formula (B3):
(R²³₃SiO_{1/2})ₐ(R²³₂R^{A}SiO_{1/2})_{b}(R²³₂SiO_{2/2})_{c}(R²³R^{A}SiO_{2/2})_{d},
where each of R²³ and R^{A} is as defined above, a quantity (a+b)=2, a quantity (b+d)≥1, and a quantity (a+b+c+d)≥2.

6. The process of claim 3, where the vinyl-functional polyorganosiloxane is a vinyl-functional polyorganosilicate resin comprising unit formula:
(R²³₃SiO_{1/2})ₘₘ(R²³₂R^{A}SiO_{1/2})ₘ(SiO_{4/2})ₒₒ(ZO_{1/2})ₕ,
where each of R²³, R^{A}, and Z is as defined above, subscripts mm, nn, and oo represent mole percentages of each unit in the polyorganosilicate resin; and subscripts mm, nn and oo have average values such that mm≥0, nn≥0, oo>0, and 0.5≤(mm+nn)/oo≤4.

7. The process of claim 3, where the vinyl-functional polyorganosiloxane is a vinyl-functional silsesquioxane resin comprising unit formula:
(R²³₃SiO_{1/2})ₐ(R²³₂R^{A}SiO_{1/2})_{b}(R²³₂SiO_{2/2})_{c}(R²³R^{A}SiO_{2/2})_{d}(R²³SiO_{3/2})ₑ(R^{A}SiO_{3/2})_{f}(ZO_{1/2})ₕ;
where each of R²³, R^{A}, and Z is as defined above, f>1; 2<(e+f)<10,000; 0<(a+b)/(e+f)<3; 0<(c+d)/(e+f)<3; and 0<h/(e+f)<1.5.

8. The process of claim 3, where each R²³ is independently selected from the group consisting of methyl and phenyl.

9. The process of claim 1, where the vinyl-functional organosilicon compound comprises a vinyl-functional silazane.

10. The process of claim 1, wherein starting material (C) has formula (C1).

11. The process of claim 1, wherein starting material (C) has formula (C2).

12. The process of claim 1, wherein starting material (C) has one of the following structures: 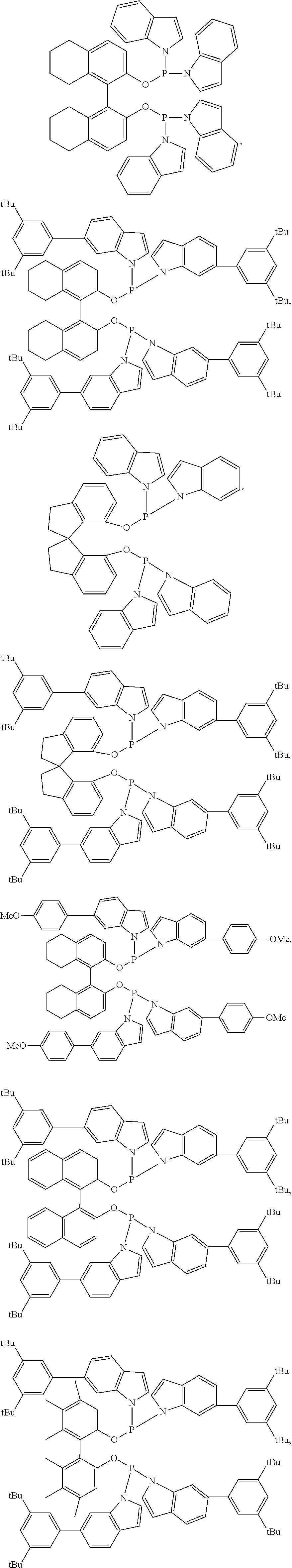 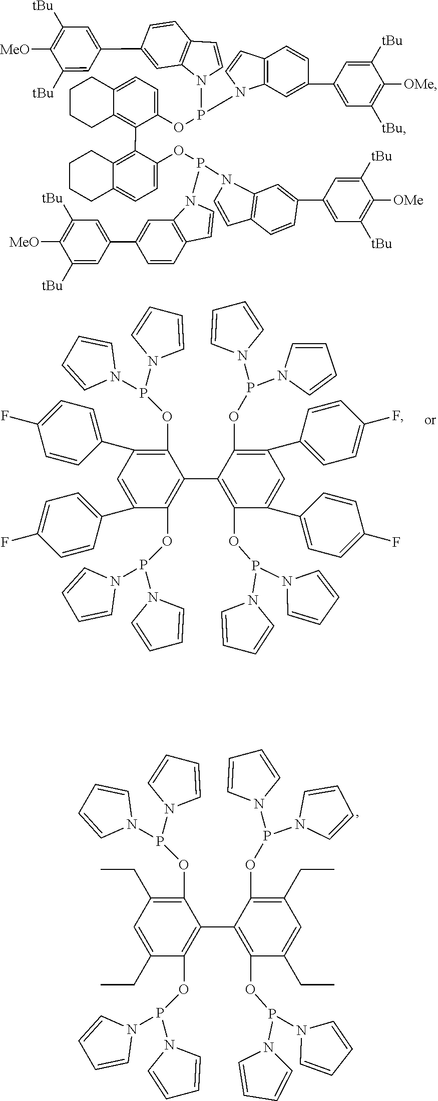
where Me indicates methyl and tBu indicates t-butyl.

13. The process of claim 1, where starting material (C) is present in an amount sufficient to provide 0.1 ppm to 300 ppm Rh based on combined weights of starting materials (A), (B), and (C).

14. The process of claim 1, where starting material (C) has a molar ratio of ligand/Rh of 1/1 to 10/1.

15. The process of claim 1, where the conditions in step 1) are selected from the group consisting of:
i) a temperature of 30° C. to 150° C.;
ii) a pressure of 101 kPa to 6,895 kPa;
iii) a molar ratio of CO/H₂ in starting material (A) of 3/1 to 1/3; and
iv) a combination of two or more of conditions i), ii) and iii).

16. The process of claim 1, where starting material (C) is formed by combining a rhodium precursor and the ligand to form a rhodium/ligand complex and combining the rhodium/ligand complex and starting material (A) with heating before step 1).
